(19) United States
(12) Patent Application Publication
(10) Pub. No.: US 2021/0226682 A1
(43) Pub. Date: Jul. 22, 2021

(54) METHOD FOR REPORTING CHANNEL STATE INFORMATION IN WIRELESS COMMUNICATION SYSTEM, AND DEVICE THEREFOR

(71) Applicant: LG ELECTRONICS INC., Seoul (KR)

(72) Inventors: Haewook PARK, Seoul (KR); Jiwon KANG, Seoul (KR); Hyungtae KIM, Seoul (KR)

(73) Assignee: LG ELECTRONICS INC., Seoul (KR)

(21) Appl. No.: 17/256,125

(22) PCT Filed: Jun. 28, 2019
(86) PCT No.: PCT/KR2019/007878

§ 371 Date: Dec. 24, 2020

(30) Foreign Application Priority Data
Jun. 28, 2018 (KR) 10-2018-0074410
Sep. 21, 2018 (KR) 10-2018-0113633

(51) Int. Cl. H04B 7/06; H04L 5/00; H04B 7/0456

(52) U.S. Cl. CPC H04B 7/0626; H04L 5/0051; H04B 7/0639; H04B 7/0632; H04B 7/0456

(57) ABSTRACT

The present specification provides a method for reporting channel state information in a wireless communication system. More specifically, a method performed by a terminal comprises: calculating, on the basis of a first CSI-RS and a second CSI-RS received from a first base station and a second base station, a first parameter related to a channel state of a first resource and a second parameter related to a channel state of a second resource or a third parameter related to a channel state of a specific resource; and reporting the first parameter and the second parameter or the third parameter to the first base station and the second base station, wherein when the third parameter is calculated, the third parameter is calculated by using a codebook related to the specific resource. In addition, CSI-RS density, a CDM setting value, a power control offset value, and a QCL are independently configured for each of a first antenna port for transmitting the first CSI-RS and a second antenna port for transmitting the second CSI-RS.

### TECHNICAL FIELD

The present disclosure relates to a wireless communication system, and more particularly, to a method for reporting channel state information and a device for supporting the same.

### BACKGROUND ART

A mobile communication system has been developed to provide A voice service while ensuring an activity of a user. However, in the mobile communication system, not only a voice but also a data service is extended. At present, due to an explosive increase in traffic, there is a shortage of resources and users demand a higher speed service, and as a result, a more developed mobile communication system is required.

Requirements of a next-generation mobile communication system should be able to support acceptance of explosive data traffic, a dramatic increase in per-user data rate, acceptance of a significant increase in the number of connected devices, very low end-to-end latency, and high-energy efficiency. To this end, various technologies are researched, which include dual connectivity, massive multiple input multiple output (MIMO), in-band full duplex, non-orthogonal multiple access (NOMA), super wideband support, device networking, and the like.

### DISCLOSURE

### Technical Problem

An embodiment of the present disclosure provides a method for reporting channel state information.

Furthermore, an embodiment of the present disclosure also provides a method for determining a codebook applied to report channel state information.

Furthermore, an embodiment of the present disclosure also provides a method for calculating a parameter for channel state information for a plurality of CSI-RSs in a CoMP system.

The technical objects of the present disclosure are not limited to the aforementioned technical objects, and other technical objects, which are not mentioned above, will be apparently appreciated by a person having ordinary skill in the art from the following description.

### Technical Solution

Provided is a method for reporting Channel State Information (CSI) in a wireless communication system.

Specifically, the method performed by a terminal includes: receiving a first Channel State Information-Reference Signal (CSI-RS) from a first base station; receiving a second CSI-RS from a second base station; calculating a first parameter related to a channel state of a first resource and a second parameter related to a channel state of a second resource or a third parameter related to a channel state of a specific resource based on the first CSI-RS and the second CSI-RS; and reporting the first parameter and the second parameter or the third parameter to the first base station and the second station, in which when the third parameter is calculated, the third parameter is calculated by using a codebook related to the specific resource, and CSI-RS density, a CDM setting value, a power control offset value, and a Quasi Co-Location (QCL) are independently configured for each of a first antenna port for transmitting the first CSI-RS and a second antenna port for transmitting the second CSI-RS.

Furthermore, in the present disclosure, the first resource is a resource for a channel through which the first CSI-RS is transmitted and the second resource is a resource for a channel through which the second CSI-RS is transmitted.

Furthermore, in the present disclosure, the codebook is determined based on a first value acquired by adding the number of antenna ports for transmitting the first CSI-RS and the number of antenna ports for transmitting the second CSI-RS, and the codebook is a codebook corresponding to the smallest number of antenna ports among a plurality of codebooks corresponding to the number of antenna ports larger than the first value.

Furthermore, in the present disclosure, in the codebook, a specific number of rows is excluded according to the first value, and the specific number is a number acquired by subtracting the first value from the number of antenna ports corresponding to the codebook.

Furthermore, in the present disclosure, the specific resource is a resource generated through aggregation of the first resource and the second resource.

Furthermore, in the present disclosure, numbers of the first antenna ports and the second antenna ports may be reset based on the codebook.

Furthermore, in the present disclosure, the specific resource is a resource for transmitting a third CSI-RS acquired by combining the first CSI-RS and the second CSI-RS.

Furthermore, in the present disclosure, when the first parameter and the second parameter are calculated, the reporting of the first parameter and the second parameter to the first base station and the second station includes reporting the first parameter to the first base station, and reporting the second parameter to the second base station.

Furthermore, in the present disclosure, the first parameter and the second parameter are calculated in a partial subband of a bandwidth constituted by a plurality of subbands according to a specific pattern.

Furthermore, in the present disclosure, the specific pattern is a pattern in which the first parameter is calculated in an even-numbered subband among the plurality of subbands, and the second parameter is calculated in an odd-numbered subband among the plurality of subbands.

Furthermore, in the present disclosure, a terminal reporting Channel State Information (CSI) in a wireless communication system includes: a radio frequency (RF) module transmitting and receiving a radio signal; and a processor functionally connected to the RF module, in which the processor is configured to receive a first Channel State Information-Reference Signal (CSI-RS) from a first base station, receive a second CSI-RS from a second base station, calculate a first parameter related to a channel state of a first resource and a second parameter related to a channel state of a second resource or a third parameter related to a channel state of a specific resource based on the first CSI-RS and the second CSI-RS, and report the first parameter and the second parameter or the third parameter to the first base station and the second station, and when the third parameter is calculated, the third parameter is calculated by using a codebook related to the specific resource, and CSI-RS density, a CDM setting value, a power control offset value, and a Quasi Co-Location (QCL) are independently configured for each of a first antenna port for transmitting the first CSI-RS and a second antenna port for transmitting the second CSI-RS.

Furthermore, in the present disclosure, the first resource is a resource for a channel through which the first CSI-RS is transmitted and the second resource is a resource for a channel through which the second CSI-RS is transmitted.

Furthermore, in the present disclosure, the codebook is determined based on a first value acquired by adding the number of antenna ports for transmitting the first CSI-RS and the number of antenna ports for transmitting the second CSI-RS, and the codebook is a codebook corresponding to the smallest number of antenna ports among a plurality of codebooks corresponding to the number of antenna ports larger than the first value.

Furthermore, in the present disclosure, in the codebook, a specific number of rows is excluded according to the first value, and the specific number is a number acquired by subtracting the first value from the number of antenna ports corresponding to the codebook.

Furthermore, in the present disclosure, the specific resource is a resource generated through aggregation of the first resource and the second resource.

Furthermore, in the present disclosure, numbers of the first antenna ports and the second antenna ports may be reset based on the codebook.

Furthermore, in the present disclosure, the specific resource is a resource for transmitting a third CSI-RS acquired by combining the first CSI-RS and the second CSI-RS.

Furthermore, in the present disclosure, when calculating the first parameter and the second parameter, the processor reports the first parameter to the first base station, and reports the second parameter to the second base station.

Furthermore, in the present disclosure, the first parameter and the second parameter are calculated in a partial subband of a bandwidth constituted by a plurality of subbands according to a specific pattern.

Furthermore, in the present disclosure, the specific pattern is a pattern in which the first parameter is calculated in an even-numbered subband among the plurality of subbands, and the second parameter is calculated in an odd-numbered subband among the plurality of subbands.

### Advantageous Effects

According to the present disclosure, there is an effect that in the CoMP system, a plurality of channel state information for a plurality of base stations can be efficiently measured and reported.

Furthermore, there is an effect that in the CoMP system, the configuration for the codebook for the plurality of channel state information for the plurality of base stations is provided to efficiently calculate the parameter for the channel state information.

Further, there is an effect that the parameter for the channel state information is calculated according to the comb pattern to reduce the payload for the channel state information.

Effects obtainable in the present disclosure are not limited to the aforementioned effects and other unmentioned effects will be clearly understood by those skilled in the art from the following description.

### DESCRIPTION OF DRAWINGS

The accompanying drawings, that are included to provide a further understanding of the present disclosure and are incorporated in and constitute a part of the present disclosure, illustrate embodiments of the present disclosure and together with the description serve to explain various principles of the present disclosure.

FIG. 1 illustrates an AI device 100 according to an embodiment of the present disclosure.

FIG. 2 illustrates an AI server 200 according to an embodiment of the present disclosure.

FIG. 3 illustrates an AI system 1 according to an embodiment of the present disclosure.

FIG. 4 illustrates an example of an overall system structure of NR to which a method proposed in the present disclosure is applicable.

FIG. 5 illustrates a relationship between an uplink frame and a downlink frame in a wireless communication system to which a method described in the present disclosure is applicable.

FIG. 6 illustrates an example of a resource grid supported in a wireless communication system to which a method described in the present disclosure is applicable.

FIG. 7 illustrates examples of a resource grid per antenna port and numerology to which a method described in the present disclosure is applicable.

FIG. 8 illustrates a self-contained subframe structure in the wireless communication system to which a method described in the present disclosure is applicable.

FIG. 9 illustrates a transceiver unit model in the wireless communication system to which a method described in the present disclosure is applicable.

FIG. 10 illustrates a hybrid beamforming structure in terms of TXRU and a physical antenna in the wireless communication system to which a method described in the present disclosure is applicable.

FIG. 11 illustrates an example of a beam sweeping operation to which a method described in the present disclosure is applicable.

FIG. 12 illustrates an example of an antenna array to which a method proposed in the present disclosure is applicable.

FIG. 13 is a diagram illustrating a CoMP configuration using a JT technique in which a method proposed in the present disclosure is performed.

FIG. 14(a) is a diagram illustrating an example of a 2 TRxP CoMP subband report to which a method proposed in the present disclosure may be applied and FIG. 14(b) is a diagram illustrating an example of a 3 TRxP CoMP subband report to which a method proposed in the present disclosure may be applied.

FIG. 15 is a diagram illustrating an example of a method for estimating channel state information proposed in the present disclosure.

FIG. 16 illustrates a block configuration diagram of a wireless communication device to which methods described in the present disclosure are applicable.

FIG. 17 illustrates another example of a block configuration diagram of a wireless communication device to which methods described in the present disclosure are applicable.

### MODE FOR INVENTION

Some embodiments of the present disclosure are described in detail with reference to the accompanying drawings. A detailed description to be disclosed along with the accompanying drawings is intended to describe some exemplary embodiments of the present disclosure and is not intended to describe a sole embodiment of the present disclosure. The following detailed description includes more details in order to provide full understanding of the present disclosure. However, those skilled in the art will understand that the present disclosure may be implemented without such more details.

In some cases, in order to avoid making the concept of the present disclosure vague, known structures and devices are omitted or may be shown in a block diagram form based on the core functions of each structure and device.

In the present disclosure, a base station has the meaning of a terminal node of a network over which the base station directly communicates with a terminal. In this document, a specific operation that is described to be performed by a base station may be performed by an upper node of the base station according to circumstances. That is, it is evident that in a network including a plurality of network nodes including a base station, various operations performed for communication with a terminal may be performed by the base station or other network nodes other than the base station. The base station (BS) may be substituted with another term, such as a fixed station, a Node B, an eNB (evolved-NodeB), a base transceiver system (BTS), or an access point (AP). Furthermore, the terminal may be fixed or may have mobility and may be substituted with another term, such as user equipment (UE), a mobile station (MS), a user terminal (UT), a mobile subscriber station (MSS), a subscriber station (SS), an advanced mobile station (AMS), a wireless terminal (WT), a machine-type communication (MTC) device, a machine-to-Machine (M2M) device, or a device-to-device (D2D) device.

Hereinafter, downlink (DL) means communication from a base station to UE, and uplink (UL) means communication from UE to a base station. In DL, a transmitter may be part of a base station, and a receiver may be part of UE. In UL, a transmitter may be part of UE, and a receiver may be part of a base station.

Specific terms used in the following description have been provided to help understanding of the present disclosure, and the use of such specific terms may be changed in various forms without departing from the technical sprit of the present disclosure.

The following technologies may be used in a variety of wireless communication systems, such as code division multiple access (CDMA), frequency division multiple access (FDMA), time division multiple access (TDMA), orthogonal frequency division multiple access (OFDMA), single carrier frequency division multiple access (SC-FDMA), and non-orthogonal multiple access (NOMA). CDMA may be implemented using a radio technology, such as universal terrestrial radio access (UTRA) or CDMA2000. TDMA may be implemented using a radio technology, such as global system for mobile communications (GSM)/general packet radio service (GPRS)/enhanced data rates for GSM evolution (EDGE). OFDMA may be implemented using a radio technology, such as Institute of electrical and electronics engineers (IEEE) 802.11 (Wi-Fi), IEEE 802.16 (WiMAX), IEEE 802.20, or evolved UTRA (E-UTRA). UTRA is part of a universal mobile telecommunications system (UMTS). 3rd generation partnership project (3GPP) Long term evolution (LTE) is part of an evolved UMTS (E-UMTS) using evolved UMTS terrestrial radio access (E-UTRA), and it adopts OFDMA in downlink and adopts SC-FDMA in uplink. LTE-advanced (LTE-A) is the evolution of 3GPP LTE.

The 5G NR defines enhanced mobile broadband (eMBB), massive machine type communications (mMTC), ultra-reliable and low latency communications (URLLC), and vehicle-to-everything (V2X) depending on usage scenarios.

The 5G NR standards are divided into standalone (SA) and non-standalone (NSA) depending on co-existence between the NR system and the LTE system.

The 5G NR supports various subcarrier spacings and supports CP-OFDM on downlink and CP-OFDM and DFT-s-OFDM (SC-OFDM) on uplink.

Embodiments of the disclosure may be supported by the standard documents disclosed in IEEE 802, 3GPP, and 3GPP2 which are radio access systems. In other words, in the embodiments of the disclosure, steps or parts skipped from description to clearly disclose the technical spirit of the present disclosure may be supported by the above documents. All the terms disclosed herein may be described by the standard documents.

For the clear description, embodiments of the present disclosure will be described focusing on 3GPP LTE/LTE-A/New Radio (NR), but the technical features of the present disclosure are not limited thereto.

In the present disclosure, ‘A/B’ or ‘A and/or B’ can be interpreted in the same sense as ‘including at least one of A or B’.

An example of 5G usage scenarios to which a method described in the present disclosure is applicable is described below.

Three major requirement areas of 5G include (1) an enhanced mobile broadband (eMBB) area, (2) a massive machine type communication (mMTC) area and (3) an ultra-reliable and low latency communications (URLLC) area.

Some use cases may require multiple areas for optimization, and other use case may be focused on only one key performance indicator (KPI). 5G support such various use cases in a flexible and reliable manner.

eMBB is far above basic mobile Internet access and covers media and entertainment applications in abundant bidirectional tasks, cloud or augmented reality. Data is one of key motive powers of 5G, and dedicated voice services may not be first seen in the 5G era. In 5G, it is expected that voice will be processed as an application program using a data connection simply provided by a communication system. Major causes for an increased traffic volume include an increase in the content size and an increase in the number of applications that require a high data transfer rate. Streaming service (audio and video), dialogue type video and mobile Internet connections will be used more widely as more devices are connected to the Internet. Such many application programs require connectivity always turned on in order to push real-time information and notification to a user. A cloud storage and application suddenly increases in the mobile communication platform, and this may be applied to both business and entertainment. Furthermore, cloud storage is a special use case that tows the growth of an uplink data transfer rate. 5G is also used for remote business of cloud. When a tactile interface is used, further lower end-to-end latency is required to maintain excellent user experiences. Entertainment, for example, cloud game and video streaming are other key elements which increase a need for the mobile broadband ability. Entertainment is essential in the smartphone and tablet anywhere including high mobility environments, such as a train, a vehicle and an airplane. Another use case is augmented reality and information search for entertainment. In this case, augmented reality requires very low latency and an instant amount of data.

Furthermore, one of the most expected 5G use case relates to a function capable of smoothly connecting embedded sensors in all fields, that is, mMTC. Until 2020, it is expected that potential IoT devices will reach 20.4 billions. The industry IoT is one of areas in which 5G performs major roles enabling smart city, asset tracking, smart utility, agriculture and security infra.

URLLC includes a new service which will change the industry through remote control of major infra and a link having ultra reliability/low available latency, such as a self-driving vehicle. A level of reliability and latency is essential for smart grid control, industry automation, robot engineering, drone control and adjustment.

Multiple use cases are described more specifically.

5G may supplement fiber-to-the-home (FTTH) and cable-based broadband (or DOCSIS) as means for providing a stream evaluated from gigabits per second to several hundreds of mega bits per second. Such fast speed is necessary to deliver TV with resolution of 4K or more (6K, 8K or more) in addition to virtual reality and augmented reality. Virtual reality (VR) and augmented reality (AR) applications include immersive sports games. A specific application program may require a special network configuration. For example, in the case of VR game, in order for game companies to minimize latency, a core server may need to be integrated with the edge network server of a network operator.

An automotive is expected to be an important and new motive power in 5G, along with many use cases for the mobile communication of an automotive. For example, entertainment for a passenger requires a high capacity and a high mobility mobile broadband at the same time. The reason for this is that future users continue to expect a high-quality connection regardless of their location and speed. Another use example of the automotive field is an augmented reality dashboard. The augmented reality dashboard overlaps and displays information, identifying an object in the dark and notifying a driver of the distance and movement of the object, over a thing seen by the driver through a front window. In the future, a wireless module enables communication between automotives, information exchange between an automotive and a supported infrastructure, and information exchange between an automotive and other connected devices (e.g., devices accompanied by a pedestrian). A safety system guides alternative courses of a behavior so that a driver can drive more safely, thereby reducing a danger of an accident. A next step will be a remotely controlled or self-driven vehicle. This requires very reliable, very fast communication between different self-driven vehicles and between an automotive and infra. In the future, a self-driven vehicle may perform all driving activities, and a driver will be focused on things other than traffic, which cannot be identified by an automotive itself. Technical requirements of a self-driven vehicle require ultra-low latency and ultra-high speed reliability so that traffic safety is increased up to a level which cannot be achieved by a person.

A smart city and smart home mentioned as a smart society will be embedded as a high-density radio sensor network. The distributed network of intelligent sensors will identify the cost of a city or home and a condition for energy-efficient maintenance. A similar configuration may be performed for each home. All of a temperature sensor, a window and heating controller, a burglar alarm and home appliances are wirelessly connected. Many of such sensors are typically a low data transfer rate, low energy and a low cost. However, for example, real-time HD video may be required for a specific type of device for surveillance.

The consumption and distribution of energy including heat or gas are highly distributed and thus require automated control of a distributed sensor network. A smart grid collects information, and interconnects such sensors using digital information and a communication technology so that the sensors operate based on the information. The information may include the behaviors of a supplier and consumer, and thus the smart grid may improve the distribution of fuel, such as electricity, in an efficient, reliable, economical, production-sustainable and automated manner. The smart grid may be considered to be another sensor network having small latency.

A health part owns many application programs which reap t he benefits of mobile communication. A communication system can support remote treatment providing clinical treatment at a distant place. This helps to reduce a barrier for the distance and can improve access to medical services which are not continuously used at remote farming areas. Furthermore, this is used to save life in important treatment and an emergency condition. A radio sensor network based on mobile communication can provide remote monitoring and sensors for parameters, such as the heart rate and blood pressure.

Radio and mobile communication becomes increasingly important in the industry application field. Wiring requires a high installation and maintenance cost. Accordingly, the possibility that a cable will be replaced with reconfigurable radio links is an attractive opportunity in many industrial fields. However, to achieve the possibility requires that a radio connection operates with latency, reliability and capacity similar to those of the cable and that management is simplified. Low latency and a low error probability is a new requirement for a connection to 5G.

Logistics and freight tracking is an important use case for mobile communication, which enables the tracking inventory and packages anywhere using a location-based information system. The logistics and freight tracking use case typically requires a low data speed, but a wide area and reliable location information.

Artificial Intelligence (AI)

Artificial intelligence means the field in which artificial intelligence or methodology capable of producing artificial intelligence is researched. Machine learning means the field in which various problems handled in the artificial intelligence field are defined and methodology for solving the problems are researched. Machine learning is also defined as an algorithm for improving performance of a task through continuous experiences for the task.

An artificial neural network (ANN) is a model used in machine learning, and is configured with artificial neurons (nodes) forming a network through a combination of synapses, and may mean the entire model having a problem-solving ability. The artificial neural network may be defined by a connection pattern between the neurons of different layers, a learning process of updating a model parameter, and an activation function for generating an output value.

The artificial neural network may include an input layer, an output layer, and optionally one or more hidden layers. Each layer includes one or more neurons. The artificial neural network may include a synapse connecting neurons. In the artificial neural network, each neuron may output a function value of an activation function for input signals, weight, and a bias input through a synapse.

A model parameter means a parameter determined through learning, and includes the weight of a synapse connection and the bias of a neuron. Furthermore, a hyper parameter means a parameter that needs to be configured prior to learning in the machine learning algorithm, and includes a learning rate, the number of times of repetitions, a mini-deployment size, and an initialization function.

An object of learning of the artificial neural network may be considered to determine a model parameter that minimizes a loss function. The loss function may be used as an index for determining an optimal model parameter in the learning process of an artificial neural network.

Machine learning may be classified into supervised learning, unsupervised learning, and reinforcement learning based on a learning method.

Supervised learning means a method of training an artificial neural network in the state in which a label for learning data has been given. The label may mean an answer (or a result value) that must be deduced by an artificial neural network when learning data is input to the artificial neural network. Unsupervised learning may mean a method of training an artificial neural network in the state in which a label for learning data has not been given. Reinforcement learning may mean a learning method in which an agent defined within an environment is trained to select a behavior or behavior sequence that maximizes accumulated compensation in each state.

Machine learning implemented as a deep neural network (DNN) including a plurality of hidden layers, among artificial neural networks, is also called deep learning. Deep learning is part of machine learning. Hereinafter, machine learning is used as a meaning including deep learning.

Robot

A robot may mean a machine that automatically processes a given task or operates based on an autonomously owned ability. Particularly, a robot having a function for recognizing an environment and autonomously determining and performing an operation may be called an intelligence type robot.

A robot may be classified for industry, medical treatment, home, and military based on its use purpose or field.

A robot includes a driving unit including an actuator or motor, and may perform various physical operations, such as moving a robot joint. Furthermore, a movable robot includes a wheel, a brake, a propeller, etc. in a driving unit, and may run on the ground or fly in the air through the driving unit.

Self-Driving (Autonomous-Driving)

Self-driving means a technology for autonomous driving. A self-driving vehicle means a vehicle that runs without a user manipulation or by a user's minimum manipulation.

For example, self-driving may include all of a technology for maintaining a driving lane, a technology for automatically controlling speed, such as adaptive cruise control, a technology for automatic driving along a predetermined path, a technology for automatically configuring a path when a destination is set and driving.

A vehicle includes all of a vehicle having only an internal combustion engine, a hybrid vehicle including both an internal combustion engine and an electric motor, and an electric vehicle having only an electric motor, and may include a train, a motorcycle, etc. in addition to the vehicles.

In this case, the self-driving vehicle may be considered to be a robot having a self-driving function.

Extended Reality (XR)

Extended reality collectively refers to virtual reality (VR), augmented reality (AR), and mixed reality (MR). The VR technology provides an object or background of the real world as a CG image only. The AR technology provides a virtually produced CG image on an actual thing image. The MR technology is a computer graphics technology for mixing and combining virtual objects with the real world and providing them.

The MR technology is similar to the AR technology in that it shows a real object and a virtual object. However, in the AR technology, a virtual object is used in a form to supplement a real object. In contrast, unlike in the AR technology, in the MR technology, a virtual object and a real object are used as the same character.

The XR technology may be applied to a head-mount display (HMD), a head-up display (HUD), a mobile phone, a tablet PC, a laptop, a desktop, TV, and a digital signage. A device to which the XR technology has been applied may be called an XR device.

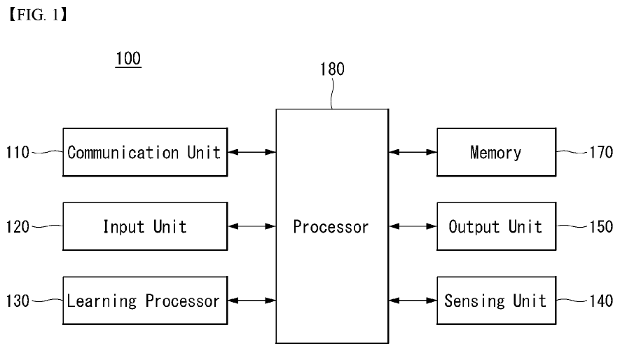

FIG. 1 illustrates an AI device 100 according to an embodiment of the disclosure.

The AI device 100 may be implemented as a fixed device or mobile device, such as TV, a projector, a mobile phone, a smartphone, a desktop computer, a notebook, a terminal for digital broadcasting, a personal digital assistants (PDA), a portable multimedia player (PMP), a navigator, a tablet PC, a wearable device, a set-top box (STB), a DMB receiver, a radio, a washing machine, a refrigerator, a desktop computer, a digital signage, a robot, and a vehicle.

Referring to FIG. 1, the terminal 100 may include a communication unit 110, an input unit 120, a learning processor 130, a sensing unit 140, an output unit 150, a memory 170 and a processor 180.

The communication unit 110 may transmit and receive data to and from external devices, such as other AI devices 100a to 100er or an AI server 200, using wired and wireless communication technologies. For example, the communication unit 110 may transmit and receive sensor information, a user input, a learning model, and a control signal to and from external devices.

In this case, communication technologies used by the communication unit 110 include a global system for mobile communication (GSM), code division multi access (CDMA), long term evolution (LTE), 5G, a wireless LAN (WLAN), wireless-fidelity (Wi-Fi), Bluetooth™, radio frequency identification (RFID), infrared data association (IrDA), ZigBee, near field communication (NFC), etc.

The input unit 120 may obtain various types of data.

In this case, the input unit 120 may include a camera for an image signal input, a microphone for receiving an audio signal, a user input unit for receiving information from a user, etc. In this case, the camera or the microphone is treated as a sensor, and a signal obtained from the camera or the microphone may be called sensing data or sensor information.

The input unit 120 may obtain learning data for model learning and input data to be used when an output is obtained using a learning model. The input unit 120 may obtain not-processed input data. In this case, the processor 180 or the learning processor 130 may extract an input feature by performing pre-processing on the input data.

The learning processor 130 may be trained by a model configured with an artificial neural network using learning data. In this case, the trained artificial neural network may be called a learning model. The learning model is used to deduce a result value of new input data not learning data. The deduced value may be used as a base for performing a given operation.

In this case, the learning processor 130 may perform AI processing along with the learning processor 240 of the AI server 200.

In this case, the learning processor 130 may include memory integrated or implemented in the AI device 100. Alternatively, the learning processor 130 may be implemented using the memory 170, external memory directly coupled to the AI device 100 or memory maintained in an external device.

The sensing unit 140 may obtain at least one of internal information of the AI device 100, surrounding environment information of the AI device 100, or user information using various sensors.

In this case, sensors included in the sensing unit 140 include a proximity sensor, an illumination sensor, an acceleration sensor, a magnetic sensor, a gyro sensor, an inertia sensor, an RGB sensor, an IR sensor, a fingerprint recognition sensor, an ultrasonic sensor, a photo sensor, a microphone, LIDAR, and a radar.

The output unit 150 may generate an output related to a visual sense, an auditory sense or a tactile sense.

In this case, the output unit 150 may include a display unit for outputting visual information, a speaker for outputting auditory information, and a haptic module for outputting tactile information.

The memory 170 may store data supporting various functions of the AI device 100. For example, the memory 170 may store input data obtained by the input unit 120, learning data, a learning model, a learning history, etc.

The processor 180 may determine at least one executable operation of the AI device 100 based on information, determined or generated using a data analysis algorithm or a machine learning algorithm. Furthermore, the processor 180 may perform the determined operation by controlling elements of the AI device 100.

To this end, the processor 180 may request, search, receive, and use the data of the learning processor 130 or the memory 170, and may control elements of the AI device 100 to execute a predicted operation or an operation determined to be preferred, among the at least one executable operation.

In this case, if association with an external device is necessary to perform the determined operation, the processor 180 may generate a control signal for controlling the corresponding external device and transmit the generated control signal to the corresponding external device.

The processor 180 may obtain intention information for a user input and transmit user requirements based on the obtained intention information.

In this case, the processor 180 may obtain the intention information, corresponding to the user input, using at least one of a speech to text (STT) engine for converting a voice input into a text string or a natural language processing (NLP) engine for obtaining intention information of a natural language.

In this case, at least some of at least one of the STT engine or the NLP engine may be configured as an artificial neural network trained based on a machine learning algorithm. Furthermore, at least one of the STT engine or the NLP engine may have been trained by the learning processor 130, may have been trained by the learning processor 240 of the AI server 200 or may have been trained by distributed processing thereof.

The processor 180 may collect history information including the operation contents of the AI device 100 or the feedback of a user for an operation, may store the history information in the memory 170 or the learning processor 130, or may transmit the history information to an external device, such as the AI server 200. The collected history information may be used to update a learning model.

The processor 18 may control at least some of the elements of the AI device 100 in order to execute an application program stored in the memory 170.

Moreover, the processor 180 may combine and drive two or more of the elements included in the AI device 100 in order to execute the application program.

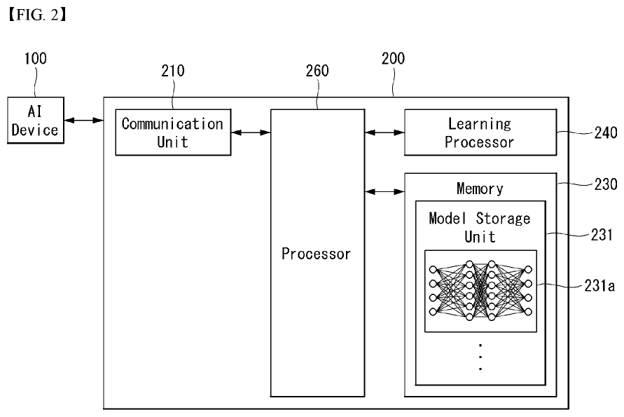

FIG. 2 illustrates an AI server 200 according to an embodiment of the disclosure.

Referring to FIG. 2, the AI server 200 may mean a device which is trained by an artificial neural network using a machine learning algorithm or which uses a trained artificial neural network. In this case, the AI server 200 is configured with a plurality of servers and may perform distributed processing and may be defined as a 5G network. In this case, the AI server 200 may be included as a partial configuration of the AI device 100, and may perform at least some of AI processing.

The AI server 200 may include a communication unit 210, a memory 230, a learning processor 240 and a processor 260.

The communication unit 210 may transmit and receive data to and from an external device, such as the AI device 100.

The memory 230 may include a model storage unit 231. The model storage unit 231 may store a model (or artificial neural network 231a) which is being trained or has been trained through the learning processor 240.

The learning processor 240 may train the artificial neural network 231a using learning data. The learning model may be used in the state in which it has been mounted on the AI server 200 of the artificial neural network or may be mounted on an external device, such as the AI device 100, and used.

The learning model may be implemented as hardware, software or a combination of hardware and software. If some of or the entire learning model is implemented as software, one or more instructions configuring the learning model may be stored in the memory 230.

The processor 260 may deduce a result value of new input data using the learning model, and may generate a response or control command based on the deduced result value.

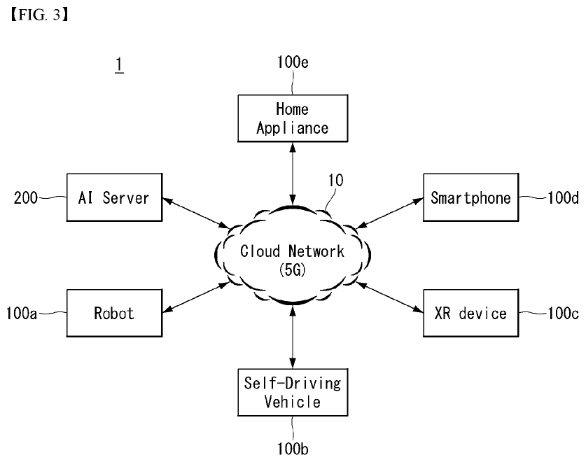

FIG. 3 illustrates an AI system 1 according to an embodiment of the disclosure.

Referring to FIG. 3, the AI system 1 is connected to at least one of the AI server 200, a robot 100a, a self-driving vehicle 100b, an XR device 100c, a smartphone 100d or home appliances 100e over a cloud network 10. In this case, the robot 100a, the self-driving vehicle 100b, the XR device 100c, the smartphone 100d or the home appliances 100e to which the AI technology has been applied may be called AI devices 100a to 100e.

The cloud network 10 may configure part of cloud computing infra or may mean a network present within cloud computing infra. In this case, the cloud network 10 may be configured using the 3G network, the 4G or long term evolution (LTE) network or the 5G network.

That is, the devices 100a to 100e (200) configuring the AI system 1 may be interconnected over the cloud network 10. Particularly, the devices 100a to 100e and 200 may communicate with each other through a base station, but may directly communicate with each other without the intervention of a base station.

The AI server 200 may include a server for performing AI processing and a server for performing calculation on big data.

The AI server 200 is connected to at least one of the robot 100a, the self-driving vehicle 100b, the XR device 100c, the smartphone 100d or the home appliances 100e, that is, AI devices configuring the AI system 1, over the cloud network 10, and may help at least some of the AI processing of the connected AI devices 100a to 100e.

In this case, the AI server 200 may train an artificial neural network based on a machine learning algorithm in place of the AI devices 100a to 100e, may directly store a learning model or may transmit the learning model to the AI devices 100a to 100e.

In this case, the AI server 200 may receive input data from the AI devices 100a to 100e, may deduce a result value of the received input data using the learning model, may generate a response or control command based on the deduced result value, and may transmit the response or control command to the AI devices 100a to 100e.

Alternatively, the AI devices 100a to 100e may directly deduce a result value of input data using a learning model, and may generate a response or control command based on the deduced result value.

Hereinafter, various embodiments of the AI devices 100a to 100e to which the above-described technology is applied are described. In this case, the AI devices 100a to 100e shown in FIG. 3 may be considered to be detailed embodiments of the AI device 100 shown in FIG. 1.

AI+Robot

An AI technology is applied to the robot 100a, and the robot 100a may be implemented as a guidance robot, a transport robot, a cleaning robot, a wearable robot, an entertainment robot, a pet robot, an unmanned flight robot, etc.

The robot 100a may include a robot control module for controlling an operation. The robot control module may mean a software module or a chip in which a software module has been implemented using hardware.

The robot 100a may obtain state information of the robot 100a, may detect (recognize) a surrounding environment and object, may generate map data, may determine a moving path and a running plan, may determine a response to a user interaction, or may determine an operation using sensor information obtained from various types of sensors.

In this case, the robot 100a may use sensor information obtained by at least one sensor among LIDAR, a radar, and a camera in order to determine the moving path and running plan.

The robot 100a may perform the above operations using a learning model configured with at least one artificial neural network. For example, the robot 100a may recognize a surrounding environment and object using a learning model, and may determine an operation using recognized surrounding environment information or object information. In this case, the learning model may have been directly trained in the robot 100a or may have been trained in an external device, such as the AI server 200.

In this case, the robot 100a may directly generate results using the learning model and perform an operation, but may perform an operation by transmitting sensor information to an external device, such as the AI server 200, and receiving results generated in response thereto.

The robot 100a may determine a moving path and running plan using at least one of map data, object information detected from sensor information, or object information obtained from an external device. The robot 100a may run along the determined moving path and running plan by controlling the driving unit.

The map data may include object identification information for various objects disposed in the space in which the robot 100a moves. For example, the map data may include object identification information for fixed objects, such as a wall and a door, and movable objects, such as a flowport and a desk. Furthermore, the object identification information may include a name, a type, a distance, a location, etc.

Furthermore, the robot 100a may perform an operation or run by controlling the driving unit based on a user's control/interaction. In this case, the robot 100a may obtain intention information of an interaction according to a user's behavior or voice speaking, may determine a response based on the obtained intention information, and may perform an operation.

AI+Self-Driving

An AI technology is applied to the self-driving vehicle 100b, and the self-driving vehicle 100b may be implemented as a movable type robot, a vehicle, an unmanned flight body, etc.

The self-driving vehicle 100b may include a self-driving control module for controlling a self-driving function. The self-driving control module may mean a software module or a chip in which a software module has been implemented using hardware. The self-driving control module may be included in the self-driving vehicle 100b as an element of the self-driving vehicle 100b, but may be configured as separate hardware outside the self-driving vehicle 100b and connected to the self-driving vehicle 100b.

The self-driving vehicle 100b may obtain state information of the self-driving vehicle 100b, may detect (recognize) a surrounding environment and object, may generate map data, may determine a moving path and running plan, or may determine an operation using sensor information obtained from various types of sensors.

In this case, in order to determine the moving path and running plan, like the robot 100a, the self-driving vehicle 100b may use sensor information obtained from at least one sensor among LIDAR, a radar and a camera.

Particularly, the self-driving vehicle 100b may recognize an environment or object in an area whose view is blocked or an area of a given distance or more by receiving sensor information for the environment or object from external devices, or may directly receive recognized information for the environment or object from external devices.

The self-driving vehicle 100b may perform the above operations using a learning model configured with at least one artificial neural network. For example, the self-driving vehicle 100b may recognize a surrounding environment and object using a learning model, and may determine the flow of running using recognized surrounding environment information or object information. In this case, the learning model may have been directly trained in the self-driving vehicle 100b or may have been trained in an external device, such as the AI server 200.

In this case, the self-driving vehicle 100b may directly generate results using the learning model and perform an operation, but may perform an operation by transmitting sensor information to an external device, such as the AI server 200, and receiving results generated in response thereto.

The self-driving vehicle 100b may determine a moving path and running plan using at least one of map data, object information detected from sensor information or object information obtained from an external device. The self-driving vehicle 100b may run based on the determined moving path and running plan by controlling the driving unit.

The map data may include object identification information for various objects disposed in the space (e.g., road) in which the self-driving vehicle 100b runs. For example, the map data may include object identification information for fixed objects, such as a streetlight, a rock, and a building, etc., and movable objects, such as a vehicle and a pedestrian. Furthermore, the object identification information may include a name, a type, a distance, a location, etc.

Furthermore, the self-driving vehicle 100b may perform an operation or may run by controlling the driving unit based on a user's control/interaction. In this case, the self-driving vehicle 100b may obtain intention information of an interaction according to a user' behavior or voice speaking, may determine a response based on the obtained intention information, and may perform an operation.

AI+XR

An AI technology is applied to the XR device 100c, and the XR device 100c may be implemented as a head-mount display, a head-up display provided in a vehicle, television, a mobile phone, a smartphone, a computer, a wearable device, home appliances, a digital signage, a vehicle, a fixed type robot or a movable type robot.

The XR device 100c may generate location data and attributes data for three-dimensional points by analyzing three-dimensional point cloud data or image data obtained through various sensors or from an external device, may obtain information on a surrounding space or real object based on the generated location data and attributes data, and may output an XR object by rendering the XR object. For example, the XR device 100c may output an XR object, including additional information for a recognized object, by making the XR object correspond to the corresponding recognized object.

The XR device 100c may perform the above operations using a learning model configured with at least one artificial neural network. For example, the XR device 100c may recognize a real object in three-dimensional point cloud data or image data using a learning model, and may provide information corresponding to the recognized real object. In this case, the learning model may have been directly trained in the XR device 100c or may have been trained in an external device, such as the AI server 200.

In this case, the XR device 100c may directly generate results using a learning model and perform an operation, but may perform an operation by transmitting sensor information to an external device, such as the AI server 200, and receiving results generated in response thereto.

AI+Robot+Self-Driving

An AI technology and a self-driving technology are applied to the robot 100a, and the robot 100a may be implemented as a guidance robot, a transport robot, a cleaning robot, a wearable robot, an entertainment robot, a pet robot, an unmanned flight robot, etc.

The robot 100a to which the AI technology and the self-driving technology have been applied may mean a robot itself having a self-driving function or may mean the robot 100a interacting with the self-driving vehicle 100b.

The robot 100a having the self-driving function may collectively refer to devices that autonomously move along a given flow without control of a user or autonomously determine a flow and move.

The robot 100a and the self-driving vehicle 100b having the self-driving function may use a common sensing method in order to determine one or more of a moving path or a running plan. For example, the robot 100a and the self-driving vehicle 100b having the self-driving function may determine one or more of a moving path or a running plan using information sensed through LIDAR, a radar, a camera, etc.

The robot 100a interacting with the self-driving vehicle 100b is present separately from the self-driving vehicle 100b, and may perform an operation associated with a self-driving function inside or outside the self-driving vehicle 100b or associated with a user got in the self-driving vehicle 100b.

In this case, the robot 100a interacting with the self-driving vehicle 100b may control or assist the self-driving function of the self-driving vehicle 100b by obtaining sensor information in place of the self-driving vehicle 100b and providing the sensor information to the self-driving vehicle 100b, or by obtaining sensor information, generating surrounding environment information or object information, and providing the surrounding environment information or object information to the self-driving vehicle 100b.

Alternatively, the robot 100a interacting with the self-driving vehicle 100b may control the function of the self-driving vehicle 100b by monitoring a user got in the self-driving vehicle 100b or through an interaction with a user. For example, if a driver is determined to be a drowsiness state, the robot 100a may activate the self-driving function of the self-driving vehicle 100b or assist control of the driving unit of the self-driving vehicle 100b. In this case, the function of the self-driving vehicle 100b controlled by the robot 100a may include a function provided by a navigation system or audio system provided within the self-driving vehicle 100b, in addition to a self-driving function simply.

Alternatively, the robot 100a interacting with the self-driving vehicle 100b may provide information to the self-driving vehicle 100b or may assist a function outside the self-driving vehicle 100b. For example, the robot 100a may provide the self-driving vehicle 100b with traffic information, including signal information, as in a smart traffic light, and may automatically connect an electric charger to a filling inlet through an interaction with the self-driving vehicle 100b as in the automatic electric charger of an electric vehicle.

AI+Robot+XR

An AI technology and an XR technology are applied to the robot 100a, and the robot 100a may be implemented as a guidance robot, a transport robot, a cleaning robot, a wearable robot, an entertainment robot, a pet robot, an unmanned flight robot, a drone, etc.

The robot 100a to which the XR technology has been applied may mean a robot, that is, a target of control/interaction within an XR image. In this case, the robot 100a is different from the XR device 100c, and they may operate in conjunction with each other.

When the robot 100a, that is, a target of control/interaction within an XR image, obtains sensor information from sensors including a camera, the robot 100a or the XR device 100c may generate an XR image based on the sensor information, and the XR device 100c may output the generated XR image. Furthermore, the robot 100a may operate based on a control signal received through the XR device 100c or a user's interaction.

For example, a user may identify a corresponding XR image at timing of the robot 100a, remotely operating in conjunction through an external device, such as the XR device 100c, may adjust the self-driving path of the robot 100a through an interaction, may control an operation or driving, or may identify information of a surrounding object.

AI+Self-Driving+XR

An AI technology and an XR technology are applied to the self-driving vehicle 100b, and the self-driving vehicle 100b may be implemented as a movable type robot, a vehicle, an unmanned flight body, etc.

The self-driving vehicle 100b to which the XR technology has been applied may mean a self-driving vehicle equipped with means for providing an XR image or a self-driving vehicle, that is, a target of control/interaction within an XR image. Particularly, the self-driving vehicle 100b, that is, a target of control/interaction within an XR image, is different from the XR device 100c, and they may operate in conjunction with each other.

The self-driving vehicle 100b equipped with the means for providing an XR image may obtain sensor information from sensors including a camera, and may output an XR image generated based on the obtained sensor information. For example, the self-driving vehicle 100b includes an HUD, and may provide a passenger with an XR object corresponding to a real object or an object within a screen by outputting an XR image.

In this case, when the XR object is output to the HUD, at least some of the XR object may be output with it overlapping a real object toward which a passenger's view is directed. In contrast, when the XR object is displayed on a display included within the self-driving vehicle 100b, at least some of the XR object may be output so that it overlaps an object within a screen. For example, the self-driving vehicle 100b may output XR objects corresponding to objects, such as a carriageway, another vehicle, a traffic light, a signpost, a two-wheeled vehicle, a pedestrian, and a building.

When the self-driving vehicle 100b, that is, a target of control/interaction within an XR image, obtains sensor information from sensors including a camera, the self-driving vehicle 100b or the XR device 100c may generate an XR image based on the sensor information. The XR device 100c may output the generated XR image. Furthermore, the self-driving vehicle 100b may operate based on a control signal received through an external device, such as the XR device 100c, or a user's interaction.

Definition of Terms

eLTE eNB: An eLTE eNB is an evolution of an eNB that supports connectivity to EPC and NGC.

gNB: A node which supports the NR as well as connectivity to NGC.

New RAN: A radio access network which supports either NR or E-UTRA or interfaces with the NGC.

Network slice: A network slice is a network defined by the operator customized to provide an optimized solution for a specific market scenario which demands specific requirements with end-to-end scope.

Network function: A network function is a logical node within a network infrastructure that has well-defined external interfaces and well-defined functional behavior.

NG-C: A control plane interface used on NG2 reference points between new RAN and NGC.

NG-U: A user plane interface used on NG3 reference points between new RAN and NGC.

Non-standalone NR: A deployment configuration where the gNB requires an LTE eNB as an anchor for control plane connectivity to EPC, or requires an eLTE eNB as an anchor for control plane connectivity to NGC.

Non-standalone E-UTRA: A deployment configuration where the eLTE eNB requires a gNB as an anchor for control plane connectivity to NGC.

User plane gateway: A termination point of NG-U interface.

Numerology: The numerology corresponds to one subcarrier spacing in a frequency domain. By scaling a reference subcarrier spacing by an integer N, different numerologies can be defined.

NR: NR Radio Access or New Radio

General System

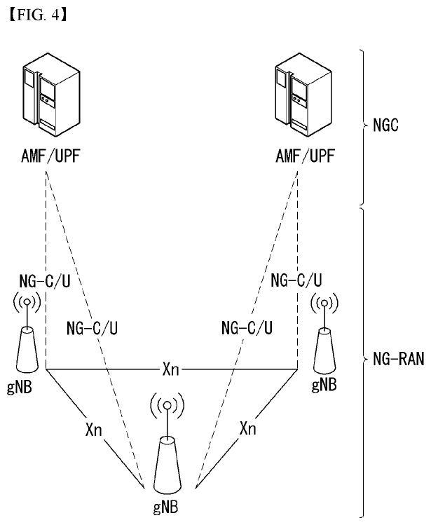

FIG. 4 is a diagram illustrating an example of an overall structure of a new radio (NR) system to which a method proposed by the present disclosure may be implemented.

Referring to FIG. 4, an NG-RAN is composed of gNBs that provide an NG-RA user plane (new AS sublayer/PDCP/RLC/MAC/PHY) and a control plane (RRC) protocol terminal for a UE (User Equipment).

The gNBs are connected to each other via an Xn interface.

The gNBs are also connected to an NGC via an NG interface.

More specifically, the gNBs are connected to a Access and Mobility Management Function (AMF) via an N2 interface and a User Plane Function (UPF) via an N3 interface.

NR (New Rat) Numerology and Frame Structure

In the NR system, multiple numerologies may be supported. The numerologies may be defined by subcarrier spacing and a CP (Cyclic Prefix) overhead. Spacing between the plurality of subcarriers may be derived by scaling basic subcarrier spacing into an integer N (or μ). In addition, although a very low subcarrier spacing is assumed not to be used at a very high subcarrier frequency, a numerology to be used may be selected independent of a frequency band.

In addition, in the NR system, a variety of frame structures according to the multiple numerologies may be supported.

Hereinafter, an Orthogonal Frequency Division Multiplexing (OFDM) numerology and a frame structure, which may be considered in the NR system, will be described.

A plurality of OFDM numerologies supported in the NR system may be defined as in Table 1.

TABLE 1

| | Δf = 2^{μ} · 15 | |
|---|---|---|
| μ | [kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |

Regarding a frame structure in the NR system, a size of various fields in the time domain is expressed as a multiple of a time unit of Tₛ=1/(Δfₘₐₓ·N_{f}). In this case, Δfₘₐₓ=480·10³, and N_{f}=4096. DL and UL transmission is configured as a radio frame having a section of T_{f}=(ΔfₘₐₓN_{f}/100)·Tₛ=10 ms. The radio frame is composed of ten subframes each having a section of T_{sf}=(ΔfₘₐₓN_{f}/1000)·Tₛ=1 ms. In this case, there may be a set of UL frames and a set of DL frames.

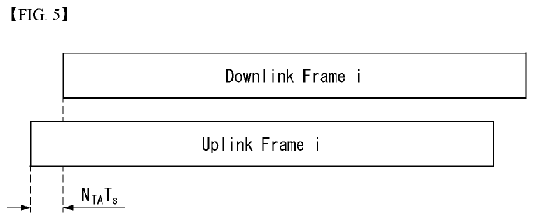

FIG. 5 illustrates a relationship between a UL frame and a DL frame in a wireless communication system to which a method proposed by the present disclosure may be implemented.

As illustrated in FIG. 5, a UL frame number I from a User Equipment (UE) needs to be transmitted T_{TA}=N_{TA}Tₛ before the start of a corresponding DL frame in the UE.

Regarding the numerology μ, slots are numbered in ascending order of nₛ^{μ}∈{0, . . . ,N_{subframe}^{slots, μ}−1} in a subframe, and in ascending order of n_{s,f}^{μ}∈{0, . . . , N_{frame}^{slots,μ}−1} in a radio frame. One slot is composed of continuous OFDM symbols of N_{symb}^{μ}, and N_{symb}^{μ} is determined depending on a numerology in use and slot configuration. The start of slots nₛ^{μ} in a subframe is temporally aligned with the start of OFDM symbols nₛ^{μ}N_{symb}^{μ} in the same subframe.

Not all UEs are able to transmit and receive at the same time, and this means that not all OFDM symbols in a DL slot or an UL slot are available to be used.

Table 2 shows the number of OFDM symbols per slot for a normal CP in the numerology μ, and Table 3 shows the number of OFDM symbols per slot for an extended CP in the numerology μ.

| | Slot configuration | | | | | |
|---|---|---|---|---|---|---|
| μ | 0 | | | 1 | | |
| | N^{μ}_{symb} | N^{slotsμ}_{symb} | N^{slotsμ}_{subframe} | N^{μ}_{symb} | N^{slotsμ}_{frame} | N^{slotsμ}_{subframe} |
| 0 | 14 | 10 | 1 | 7 | 20 | 2 |
| 1 | 14 | 20 | 2 | 7 | 40 | 4 |
| 2 | 14 | 40 | 4 | 7 | 80 | 8 |
| 3 | 14 | 80 | 8 | — | — | — |
| 4 | 14 | 160 | 16 | — | — | — |
| 5 | 14 | 320 | 32 | — | — | — |

| | Slot configuration | | | | | |
|---|---|---|---|---|---|---|
| μ | 0 | | | 1 | | |
| | N^{μ}_{symb} | N^{slotsμ}_{frame} | N^{slotsμ}_{subframe} | N^{μ}_{symb} | N^{slotsμ}_{frame} | N^{slotsμ}_{subframe} |
| 0 | 12 | 10 | 1 | 6 | 20 | 2 |
| 1 | 12 | 20 | 2 | 6 | 40 | 4 |
| 2 | 12 | 40 | 4 | 6 | 80 | 8 |
| 3 | 12 | 80 | 8 | — | — | — |
| 4 | 12 | 160 | 16 | — | — | — |
| 5 | 12 | 320 | 32 | — | — | — |

NR Physical Resource

Regarding physical resources in the NR system, an antenna port, a resource grid, a resource element, a resource block, a carrier part, etc. may be considered.

Hereinafter, the above physical resources possible to be considered in the NR system will be described in more detail.

First, regarding an antenna port, the antenna port is defined such that a channel over which a symbol on one antenna port is transmitted can be inferred from another channel over which a symbol on the same antenna port is transmitted. When large-scale properties of a channel received over which a symbol on one antenna port can be inferred from another channel over which a symbol on another antenna port is transmitted, the two antenna ports may be in a QC/QCL (quasi co-located or quasi co-location) relationship. Herein, the large-scale properties may include at least one of delay spread, Doppler spread, Doppler shift, average gain, and average delay.

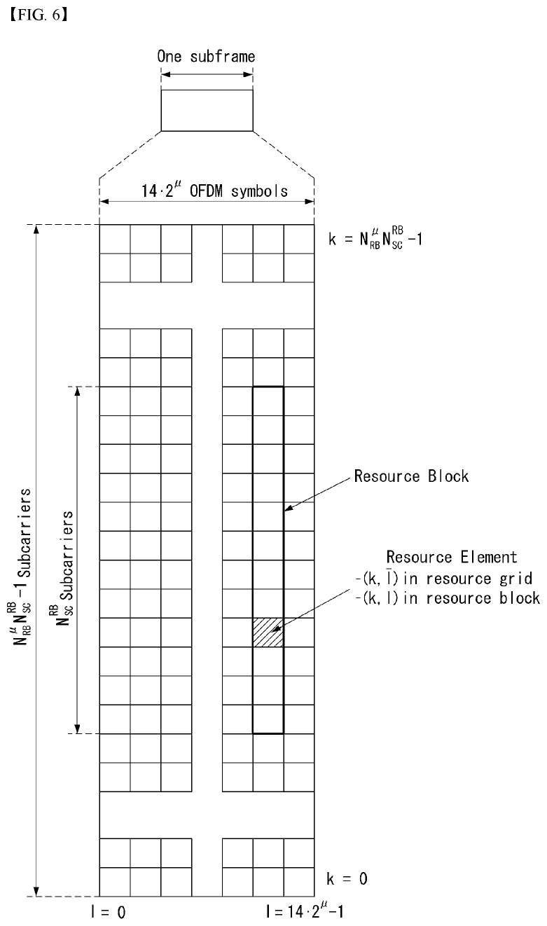

FIG. 6 illustrates an example of a resource grid supported in a wireless communication system to which a method proposed by the present disclosure may be implemented.

Referring to FIG. 6, a resource grid is composed of N_{RB}^{μ}N_{sc}^{RB} subcarriers in a frequency domain, each subframe composed of 14·2μ OFDM symbols, but the present disclosure is not limited thereto. In the NR system, a transmitted signal is described by one or more resource grids, composed of N_{RB}^{μ}N_{sc}^{RB} subcarriers, and 2^{μ}N_{symb}^{(μ)} OFDM symbols Herein, N_{RB}^{μ}≤N_{RB}^{max, μ}. The above indicates the maximum transmission bandwidth, and it may change not just between numerologies, but between UL and DL.

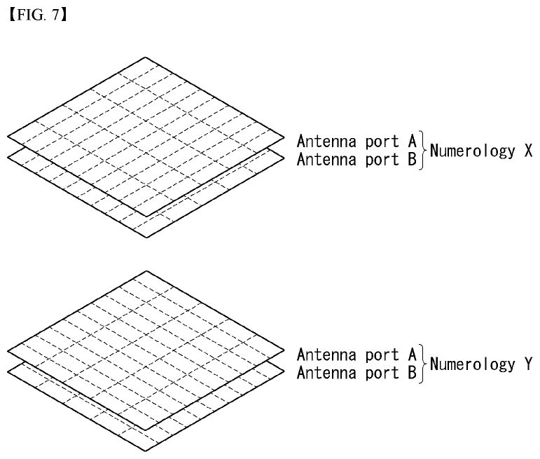

In this case, as illustrated in FIG. 7, one resource grid may be configured for the numerology μ and an antenna port p.

FIG. 7 illustrates examples of a resource grid per antenna port and numerology to which a method described in the present disclosure is applicable.

Each element of the resource grid for the numerology μ and the antenna port p is indicated as a resource element, and may be uniquely identified by an index pair (k, l̅). Herein, k=0, . . . , N_{RB}^{μ}N_{sc}^{RB}−1 is an index in the frequency domain, and l̅=0, . . . ,2^{μ}N_{symb}^{(μ)}−1 indicates a location of a symbol in a subframe. To indicate a resource element in a slot, the index pair (k, l̅) is used. Herein, l=0, . . . ,N_{symb}^{μ}−1.

The resource element (k,l̅) for the numerology μ and the antenna port p corresponds to a complex value a_{k,l̅}^{(p,μ)}. When there is no risk of confusion or when a specific antenna port or numerology is specified, the indexes p and μ may be dropped and thereby the complex value may become a_{k,l̅}^{(p)} or a_{k,l̅}.

In addition, a physical resource block is defined as N_{sc}^{RB}=12 continuous subcarriers in the frequency domain. In the frequency domain, physical resource blocks may be numbered from 0 to N_{RB}^{μ}−1. At this point, a relationship between the physical resource block number n_{PRB} and the resource elements (k, l) may be given as in Equation 1.

$${n}_{PRB} = ⌊ \frac{k}{{N}_{sc}^{RB}} ⌋ \qquad [ Equation 1 ]$$

In addition, regarding a carrier part, a UE may be configured to receive or transmit the carrier part using only a subset of a resource grid. At this point, a set of resource blocks which the UE is configured to receive or transmit are numbered from 0 to N_{URB}^{μ}−1 in the frequency region.

Self-Contained Slot Structure

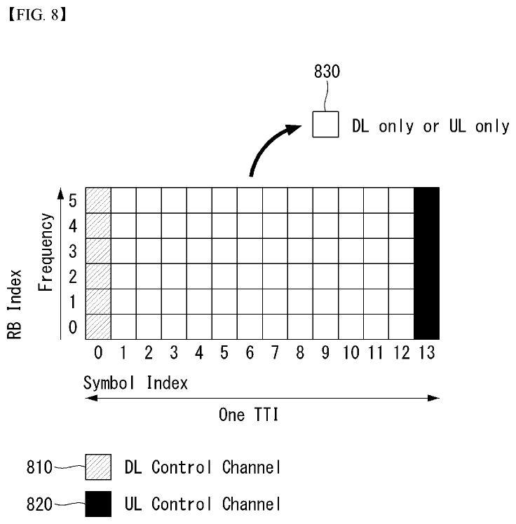

In order to minimize data transmission latency in a TDD system, 5th generation (5G) new RAT (NR) considers a self-contained subframe structure as illustrated in FIG. 8.

That is, FIG. 8 illustrates an example of a self-contained structure to which a method described in the present disclosure is applicable.

In FIG. 8, a hatched portion 810 represents a downlink control area, and a black portion 820 represents an uplink control area.

A non-hatched portion 830 may be used for downlink data transmission or for uplink data transmission.

Such a structure is characterized in that DL transmission and UL transmission are sequentially performed in one slot, and the transmission of DL data and the transmission and reception of UL ACK/NACK can be performed in one slot.

The slot described above may be defined as ‘self-contained slot’.

That is, through such a slot structure, a base station can reduce the time it takes to retransmit data to a UE when a data transmission error occurs, and hence can minimize a latency of final data transfer.

In the self-contained slot structure, a time gap is necessary for the base station and the UE to switch from a transmission mode to a reception mode or to switch from the reception mode to the transmission mode.

To this end, some OFDM symbols at a time of switching from DL to UL in the self-contained slot structure are configured as a guard period (GP).

Analog Beamforming

Since a wavelength is short in a Millimeter Wave (mmW) range, a plurality of antenna elements may be installed in the same size of area. That is, a wavelength in the frequency band 30 GHz is 1 cm, and thus, 64 (8×8) antenna elements may be installed in two-dimensional arrangement with a 0.5 lambda (that is, a wavelength) in 4×4 (4 by 4) cm panel. Therefore, in the mmW range, the coverage may be enhanced or a throughput may be increased by increasing a beamforming (BF) gain with a plurality of antenna elements.

In this case, in order to enable adjusting transmission power and phase for each antenna element, if a transceiver unit (TXRU) is included, independent beamforming for each frequency resource is possible. However, it is not cost-efficient to install TXRU at each of about 100 antenna elements. Thus, a method is considered in which a plurality of antenna elements is mapped to one TXRU and a direction of beam is adjusted with an analog phase shifter. Such an analog BF method is able to make only one beam direction over the entire frequency band, and there is a disadvantage that frequency-selective BF is not allowed.

A hybrid BF may be considered which is an intermediate between digital BF and analog BF, and which has B number of TXRU less than Q number of antenna elements. In this case, although varying depending upon a method of connecting B number of TXRU and Q number of antenna elements, beam directions capable of being transmitted at the same time is restricted to be less than B.

Hereinafter, typical examples of a method of connecting TXRU and antenna elements will be described with reference to drawings.

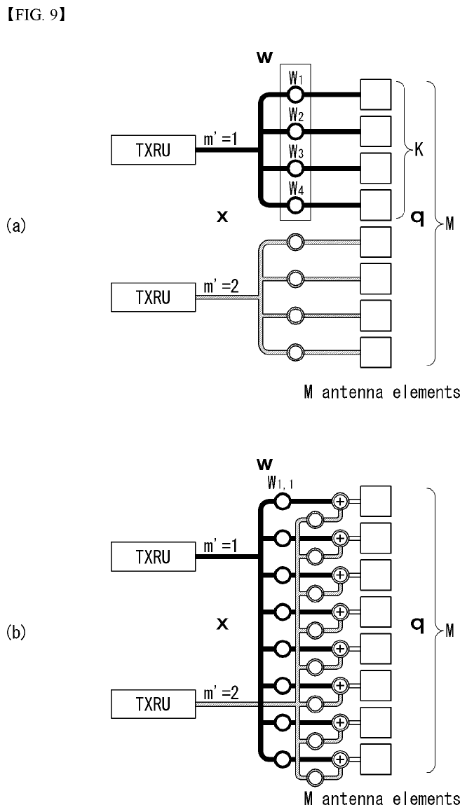

FIG. 9 is an example of a transceiver unit model in a wireless communication system to which the present disclosure may be implemented.

A TXRU virtualization model represents a relationship between output signals from TXRUs and output signals from antenna elements. Depending on a relationship between antenna elements and TXRUs, the TXRU virtualization model may be classified as a TXRU virtualization model option-1: sub-array partition model, as shown in FIG. 9(a), or as a TXRU virtualization model option-2: full-connection model.

Referring to FIG. 9(a), in the sub-array partition model, the antenna elements are divided into multiple antenna element groups, and each TXRU may be connected to one of the multiple antenna element groups. In this case, the antenna elements are connected to only one TXRU.

Referring to FIG. 9(b), in the full-connection model, signals from multiple TXRUs are combined and transmitted to a single antenna element (or arrangement of antenna elements). That is, this shows a method in which a TXRU is connected to all antenna elements. In this case, the antenna elements are connected to all the TXRUs.

In FIG. 9, q represents a transmitted signal vector of antenna elements having M number of co-polarized in one column. W represents a wideband TXRU virtualization weight vector, and W represents a phase vector to be multiplied by an analog phase shifter. That is, a direction of analog beamforming is decided by W. x represents a signal vector of M_TXRU number of TXRUs.

Herein, mapping of the antenna ports and TXRUs may be performed on the basis of 1-to-1 or 1-to-many.

TXRU-to-element mapping In FIG. 9 is merely an example, and the present disclosure is not limited thereto and may be equivalently applied even to mapping of TXRUs and antenna elements which can be implemented in a variety of hardware forms.

In the next system (e.g., 5G), depending on the application field and/or the type of traffic, the UE does not receive the UL grant before performing the uplink transmission and performs uplink transmission in a semi-persistent resource and it is possible to perform a configured grant transmission. In addition, in the existing system, that is, LTE, a similar operation is possible in DL and UL through semi-persistent scheduling (SPS). In the configured grant transmission, a radio resource which different UEs share based on a contention or a radio resource dedicatedly allocated to the UE may be used. For the configured grant transmission, since a UL grant receiving operation is not required prior to the transmission, the radio resources may be utilized in a service or traffic of a field requiring a lower latency time. It is considered that the radio resource used for the configured grant transmission uses a different modulation and coding scheme or a different transmission block size or a different transmission time interval (TT) from a radio resource allocated through the UL grant. The UE may be allocated with one or multiple radio resources for the configured grant transmission. Multiple radio resources used for the configured grant transmission may be have the same or different size or modulation encoding scheme, time and/or frequency scheduling units and overlapping may be allowed. A method in which the UE attempts to transmit the same data several times in order to increase a success rate of the configured grant transmission is also considered. In the next system, a separated RRC configuration may be performed for configured grant transmission.

Further, in a New RAT system, when multiple antennas are used, a hybrid beam forming technique combining digital beam forming and analog beam forming is emerging. In this case, the analog beamforming (or radio frequency (RF) beamforming) means an operation of performing precoding (or combining) in an RF stage. In the hybrid beamforming, each of a baseband stage and the RF stage perform precoding (or combining), thereby reducing the number of RF chains and the number of digital (D)/analog (A) converters and achieving performance close to the digital beamforming. For convenience, the hybrid beamforming structure may be represented by N transceiver units (TXRU) and M physical antennas. Then, the digital beamforming for L data layers to be transmitted by the transmitter may be represented by an N by L matrix, and then the N digital signals converted are converted into an analog signal via the TXRU and then applied the analog beamforming represented by an M by N matrix.

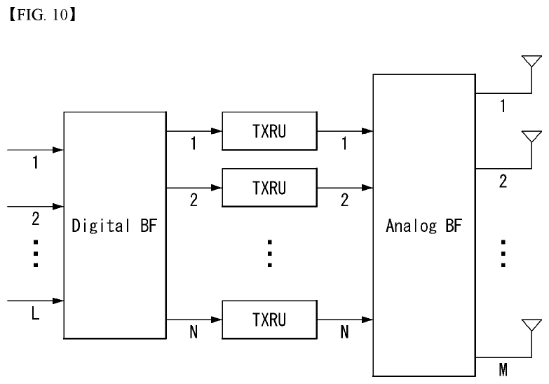

FIG. 10 is a diagram illustrating a hybrid beamforming structure in terms of TXRU and a physical antenna in the wireless communication system to which the method proposed in the present disclosure may be applied.

In FIG. 10, a case where the number of digital beams is L and the number of analog beams is N is illustrated.

In the New RAT system, considered is a direction in which it is designed so that the BS may change the analog beamforming by the unit of the symbol to support more efficient beamforming to a UE positioned in a specific region. Furthermore, in FIG. 10, when N specific TXRUs and M specific RF antennas are defined as one antenna panel, a scheme that introduces a plurality of antenna panels capable of independent hybrid beamforming is also considered in the New RAT system.

Feedback of Channel State Information (CSI)

In a 3GPP LTE/LTE-A system, user equipment (UE) is defined to report channel state information (CSI) to a base station (BS or eNB).

The CSI collectively refers to information that can indicate the quality of a radio channel (or referred to as a link) formed between the UE and the antenna port. For example, a rank indicator (RI), a precoding matrix indicator (PMI), a channel quality indicator (CQI), and the like correspond to the information.

Here, the RI represents rank information of a channel, which means the number of streams received by the UE through the same time-frequency resource. Since this value is determined depending on the long term fading of the channel, the value is fed back from the UE to the BS with a period usually longer than the PMI and the CQI. The PMI is a value reflecting a channel space characteristic and represents a preferred precoding index preferred by the UE based on a metric such as signal-to-interference-plus-noise ratio (SINR). The CQI is a value representing the strength of the channel, and generally refers to a reception SINR that can be obtained when the BS uses the PMI.

In the 3GPP LTE/LTE-A system, the BS configures a plurality of CSI processes to the UE and may receive CSI for each process. Here, the CSI process is constituted by a CSI-RS for signal quality measurement from the BS and a CSI-interference measurement (CSI-IM) resource for interference measurement.

Virtualization of Reference Signal (RS)

In the mmW, it is possible to transmit a PDSCH only in one analog beam direction at a time by analog beamforming. In this case, data transmission from the BS is possible only to a small number of UEs in the corresponding direction. Therefore, if necessary, the analog beam direction is differently configured for each antenna port so that data transmission can be simultaneously performed to a plurality of UEs in several analog beam directions.

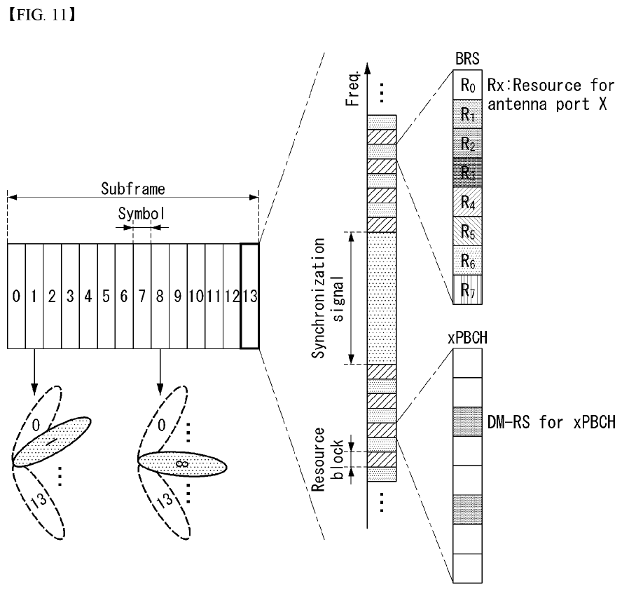

FIG. 11 is a diagram illustrating an example of a beam sweeping operation to which the method proposed in the present disclosure may be applied.

As described in FIG. 10, when the BS uses a plurality of analog beams, a beam sweeping operation is considered, which allows all UEs to have a reception opportunity by changing a plurality of analog beams to which the BS intends to apply in a specific subframe according to the symbol at least with respect to a synchronization signal, system information, and a paging signal because an analog beam which is advantageous for signal reception for each UE.

FIG. 11 illustrates an example of a beam sweeping operation for a synchronization signal and system information in a downlink transmission process. In FIG. 11, a physical resource (or physical channel) through which the system information is transmitted in a broadcasting scheme in the New RAT is referred to as physical broadcast channel (xPBCH).

In this case, analog beams belonging to different antenna panels within one symbol may be simultaneously transmitted and discussed is a scheme that introduces a beam reference signal (BRS) which is a reference signal transmitted, to which a single analog beam (corresponding to a specific antenna panel) is applied as illustrated in FIG. 8 to measure channels depending on the analog beam.

The BRS may be defined for a plurality of antenna ports and each antenna port of the BRS may correspond to the single analog beam.

In this case, unlike the BRS, the synchronization signal or xPBCH may be transmitted, to which all of the analog beams in the analog beam group are applied so that the signal may be well received by random UEs.

RRM Measurement

The LTE system supports RRM operations including power control, scheduling, cell search, cell reselection, handover, radio link or connection monitoring, connection establishment/re-establishment, and the like.

In this case, the serving cell may request RRM measurement information, which is a measurement value for performing the RRM operations, to the UE.

For example, the UE may measure information including cell search information for each cell, reference signal received power (RSRP), reference signal received quality (RSRQ), and the like and report the measured information to the BS. Specifically, in the LTE system, the UE receives ‘measConfig’ as a higher layer signal for RRM measurement from the serving cell. The UE measures the RSRP or RSRQ according to ‘measConfig’.

The RSRP, the RSRQ, and the RSSI are defined as below.

RSRP: The RSRP may be defined as a linear average of a power contribution [W] of a resource element carrying a cell specific reference signal within a considered measurement frequency bandwidth. A cell specific reference signal R0 may be used for deciding the RSRP. When the UE may reliably detect that RI is available, the UE may decide the RSRP by using RI in addition to R0.

A reference point of the RSRP may be an antenna connector of the UE.

When receiver diversity is used by the UE, a reported value need not be smaller than the RSRP corresponding to a random individual diversity branch.

RSRQ: The reference signal received quality (RSRQ) is defined as a ratio N×RSRP/(E-UTRA carrier RSSI) and N represents the number of RBs of an E-UTRA carrier RSSI measurement bandwidth. Measurements of numerator and denominator should be performed through the same set of resource blocks.

The E-UTRA carrier received signal strength indicator (RSSI) is received through a block by the UE from all sources including N resource adjacent channel interference, thermal noise, etc., in a linear average of the total received power [W] measured only in an OFDM symbol containing a reference symbol for antenna port 0 and a measurement bandwidth.

When the higher layer signaling represents a specific subframe for performing the RSRQ measurement, the RSSI is measured for all OFDM symbols in the indicated subframe.

The reference point for the RSRQ should be the antenna connector of the UE.

When the receiver diversity is used by the UE, the reported value should not be smaller than the corresponding RSRQ of the random individual diversity branch.

RSSI: The RSSI means received broadband power including thermal noise and noise generated at the receiver within a bandwidth defined by a receiver pulse shaping filter.

The reference point for measuring the RSSI should be the antenna connector of the UE. When the receiver diversity is used by the UE, the reported value should not be smaller than the corresponding UTRA carrier RSSI of the random individual receive antenna branch.

According to such a definition, the UE which operates in the LTE system may be allowed to measure the RSRP in a bandwidth corresponding to one of 6, 15, 25, 50, 75, and 100 resource blocks (RBs) through an information element (IE) related with an allowed measurement bandwidth transmitted system information block type 3 (SIB3) in the case of intra-frequency measurement and through an allowed measurement bandwidth transmitted in SIB5 in the case of inter-frequency measurement.

Alternatively, in the absence of such an IE, the measurement may be performed in a frequency band of the entire downlink (DL) system by default. In this case, when the UE receives the allowed measurement bandwidth, the UE may consider the corresponding value as a maximum measurement bandwidth and arbitrarily measure the value of the RSRP within the corresponding value.

However, when the serving cell transmits an IE defined as WB-RSRQ and the allowed measurement bandwidth is set to 50 RB or more, the UE needs to calculate the RSRP value for the entire allowed measurement bandwidth. Meanwhile, the RSSI may be measured in the frequency band of the receiver of the UE according to the definition of the RSSI bandwidth.

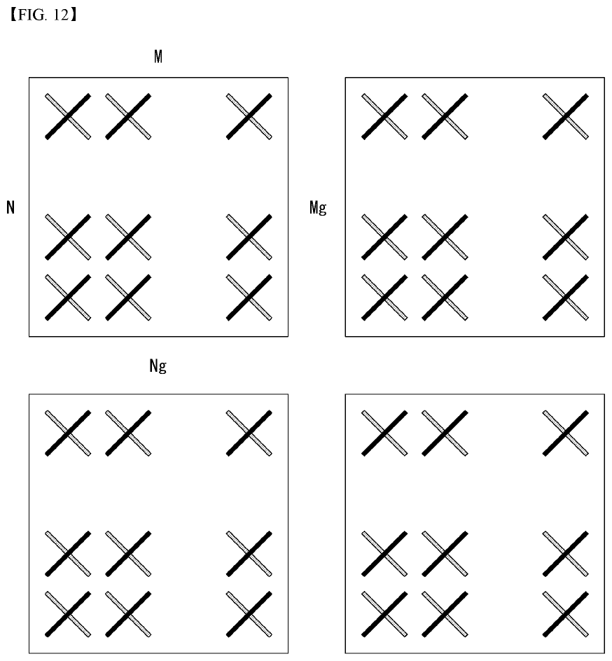

FIG. 12 is a diagram illustrating an example of an antenna array to which the method proposed in the present disclosure may be applied.

Referring to FIG. 12, the normalized panel antenna array may be constituted by Mg panels and Ng panels in a horizontal domain and a vertical domain, respectively.

In this case, one panel is constituted by M columns and N rows, respectively, and an X-pol antenna is assumed in FIG. 12. Therefore, the total number of antenna elements may be 2*M*N*Mg*Ng.

Antenna Port Quasi Co-Location

The UE may be configured with a list of up to the M number of TCI-State configurations in a higher layer parameter PDSCH-Config so as to decode the PDSCH according to the detected PDCCH having DCI intended for the corresponding UE and a given serving cell. The M depends on UE capability.

Each TCI-State includes parameters for establishing a quasi co-location relationship between one or two DL reference signals and the DM-RS port of the PDSCH.

The quasi co-location relationship is set to a higher layer parameter qcl-Type1 for a first DL RS and qcl-Type2 (if set) for a second DL RS.

In the case of two DL RSs, the QCL type is not the same regardless of whether the reference is the same DL RS or different DL RSs.

The quasi co-location type corresponding to each DL RS is given by the higher layer parameter qcl-Type of QCL-Info and may take one of the following values:

‘QCL-TypeA’: {Doppler shift, Doppler spread, average delay, delay spread}

‘QCL-TypeB’: {Doppler shift, Doppler spread}

‘QCL-TypeC’: {Doppler shift, average delay}

‘QCL-TypeD’: {Spatial Rx parameter}

The UE receives an activation command used for mapping up to 8 TCI states to a codepoint of the DCI field ‘Transmission Configuration Indication’.

When HARQ-ACK corresponding to the PDSCH carrying the activation command is transmitted on slot n, mapping between codepoints of the DCI field ‘Transmission Configuration Indication’ and the TCI states should be started from n+3Nₛₗₒₜ^{subframe, μ}+1.

Before the UE receives the higher layer configuration of the TCI states and receives the activation command, the UE may assume that antenna ports of one DM-RS port group of the PDSCH of the serving cell has a quasi co-location relationship with the SS/PBCH block determined in an initial access procedure for ‘QCL-TypeA’ and if applicable, the same is applied even to ‘QCL-TypeD’.

When the UE is configured to the higher layer parameter ‘tci-PresentInDCI’ configured to ‘enable’ for CORESET for scheduling the PDSCH, the UE assumes that the RCI field is present in DCI format 1_1 of the PDCCH transmitted from the CORESET.

In the case where ‘tci-PresentInDCI’ is configured to ‘enable’, when the PDSCH is scheduled according to DCI format 1_1, the UE should use TCI-State according to the DCI and the value of the ‘Transmission Configuration Indication’ field of the detected PDCCH in order to determine the PDSCH antenna port quasi co-location.

When a time offset between reception of the downlink DCI and the corresponding PDSCH is equal to or more than threshold ‘Threshold-Sched-Offset’ based on the UE capability reported, the UE assumes that the antenna ports of one DM-RS port group of the PDSCH of the serving cell is quasi co-located with a reference signal of the TCI state of the QCL type parameter given by the indicated TCI state.

When an offset between reception of the downlink DCI and the corresponding PDSCH is less than the threshold ‘Threshold-Sched-Offset’, the UE may assume that the antenna ports of one DM-RS port group of the PDSCH of the serving cell is quasi co-located with the reference signals of the TCI state for the QCL parameter(s) used for PDCCH quasi co-location.

In this case, the QCL parameter(s) is a parameter(s) used for PDCCH quasi co-location of a lowest CORESET-ID in a latest slot in which one or more CORESET(s) in the active BWP of the serving cell are configured for the UE.

When none of the configured TCI states includes ‘QCL-TypeD’, the UE should acquire other QCL assumptions from the TCI state indicated for the scheduled PDSCH regardless of the time offset between the reception of the downlink DCI and the corresponding PDSCH.

In the case of the higher layer parameter trs-Info and the periodic CSI-RS resource of configured NZP-CSI-RS-ResourceSet, the UE may expect that the TCI-state will indicate the following quasi co-location type(s).

‘QCL-TypeC’ with SS/PBCH block and ‘QCL-TypeD’ with the same SS/PBCH block if applicable

‘QCL-TypeC’ with SS/PBCH block, and CSI-RS resource of NZP-CSI-RS-ResourceSet configured by higher parameter repetition and ‘QCL-TypeD’ if applicable

In the case of the periodic CSI-RS resource of NZP-CSI-RS-ResourceSet configured to the higher layer parameter trs-Info, the UE expects that the TCI-State indicates the periodic CSI-RS of NZP-CSI-RS-ResourceSet configured to the higher layer parameter trs-Info and ‘QCL-TypeD’ and expects that the TCI-State indicates the same periodic CSI-RS resource and ‘QCL-TypeD’ if applicable.

For the higher layer parameter trs-Info and the CSI-RS resource of NZP-CSI-RS-ResourceSet configured without repetition, the UE may expect that the TCI-state indicates the following quasi co-location type(s).

‘QCL-TypeA’ having the higher layer parameter trs-Info and the CSI-RS resource of the configured NZP-CSI-RS-ResourceSet and if available, ‘QCL-TypeD’ having the SS/PBCK block, or

‘QCL-TypeA’ having the higher layer parameter trs-Info and the CSI-RS resource of the configured NZP-CSI-RS-ResourceSet and if available, ‘QCL-TypeD’ having the higher layer parameter repetition and the CSI-RS resource of the configured NZP-CSI-RS-ResourceSet, or

if ‘QCL-TypeD’ is not available, ‘QCL-TypeB’ having the higher layer parameter trs-Info and the CSI-RS resource of the configured NZP-CSI-RS-ResourceSet

For the higher layer parameter trs-Info and the CSI-RS resource of the configured NZP-CSI-RS-ResourceSet, the UE expects that the TCI-state indicates the following quasi co-location type(s).

‘QCL-TypeA’ having the higher layer parameter trs-Info and the CSI-RS resource of the configured NZP-CSI-RS-ResourceSet and if available, ‘QCL-TypeD’ having the same CSI-RS resource, or

‘QCL-TypeA’ having the higher layer parameter trs-Info and the CSI-RS resource of the configured NZP-CSI-RS-ResourceSet and if applicable, ‘QCL-TypeD’ having the higher layer parameter repetition and the CSI-RS resource of the configured NZP-CSI-RS-ResourceSet, or

‘QCL-TypeC’ with the SS/PBCH block and ‘QCL-TypeD’ with the same SS/PBCH block if available.

For the DM-RS of the PDCCH, the UE expects that the TCI-State indicates the following quasi-co-location type(s).

‘QCL-TypeA’ having the higher layer parameter trs-Info and the CSI-RS resource of the configured NZP-CSI-RS-ResourceSet and if available, ‘QCL-TypeD’ having the same CSI-RS resource, or

‘QCL-TypeA’ having the higher layer parameter trs-Info and the CSI-RS resource of the configured NZP-CSI-RS-ResourceSet and if available, ‘QCL-TypeD’ having the higher layer parameter repetition and the CSI-RS resource of the configured NZP-CSI-RS-Resource Set, or

if ‘QCL-TypeD’ is not available, ‘QCL-TypeA’ having the higher layer parameter trs-Info and the CSI-RS resource of the configured NZP-CSI-RS-ResourceSet

For the DM-RS of the PDSCH, the UE expects that the TCI-State indicates the following quasi-co-location type(s).

‘QCL-TypeA’ having the higher layer parameter trs-Info and the CSI-RS resource of the configured NZP-CSI-RS-ResourceSet and if available, ‘QCL-TypeD’ having the same CSI-RS resource, or

‘QCL-TypeA’ having the higher layer parameter trs-Info and the CSI-RS resource of the configured NZP-CSI-RS-ResourceSet and if available, ‘QCL-TypeD’ having the higher layer parameter repetition and the CSI-RS resource of the configured NZP-CSI-RS-Resource Set, or

‘QCL-TypeA’ having the higher layer parameter trs-Info and the CSI-RS resource of the NZP-CSI-RS-ResourceSet configured without repetition and if available, ‘QCL-TypeD’ having the same CSI-RS resource.

Priority Rules for CSI Reports

The CSI reports are associated with a priority value

Pri_{iCSI}(y, k, c, s)=2·N_{cells}·M_{z}·y+N_{cells}·Mₛ·k+Mₛ·c+s.

In the case of aperiodic CSI reports carried on the PUSCH, y=0, in the case of semi-persistent CSI reports carried on the PUSCH, y=1, and in the case of periodic CSI reports carried on the PUCCH, y=3.

In the case of CSI reports including L1-RSRP, k=0 and in the case of CSI reports not including L1-RSRP, k=1.

c represents a serving cell index and N_{cells} represents a value of a higher layer parameter maxNrofServingCells.

s represents reportConfigID and represents a value of a higher layer parameter maxNrofCSI-ReportConfigurations.

When a value of Pri_{iCSI}(y, k, c, s) in the first CSI report is smaller than Pri_{iCSI}(y, k, c, s) in a second CSI report, the first CSI report has a higher priority than the second CSI report.

When occupancy times in physical channels scheduled to carry the CSI report overlap in at least one OFDM symbol and are transmitted in the same carrier, two CSI reports collide with each other. When the UE is configured to transmit two CSI reports which collide with each other, the following rule is followed.

A CSI report having a higher Pri_{iCSI}(y, k, c, s) value is not transmitted by the UE.

When the semi-persistent CSI report carried on the PUSCH collides with PUSCH data transmission and when a start symbol is aligned between two channels, the CSI report is not transmitted by the UE.

CSI Report Transmission Rule

A transmission rule for the CSI report is shown in Table 4 below.

TABLE 4

```
  Rule #1: Time-domain behavior/channel (AP-CSI > SP-CSI
on PUSCH > SP-CSI on PUCCH > P-CSI)
  Rule #2: CSI content (Beam reports > CSI)
    (Applies only for all periodic reports and semi-persistent
reports intended for PUCCH)
  Rule #3: cellID (PCell > PSCell > other cell IDs in
increasing order)
    (Applies only for all periodic reports and semi-persistent
reports intended for PUCCH)
  Rule #4: csiReportID (in increasing order)
    (Applies only for all periodic reports and semi-persistent
reports intended for PUCCH)
```

According to Table 4, first, the rule is first applied in the time domain (Rule #1).

According to Rule #1, an aperiodic CSI (AP-CSI) has a higher priority than a semi-persistent CSI (SP-CSI) on the PUSCH, semi-persistent CSI on the PUSCH has a higher priority than semi-persistent CSI on the PUCCH, and semi-persistent CSI has a higher priority than periodic CSI (P-CSI).

Next, Rule #2 is applied.

According to Rule #2, the priority is determined by CSI contents and a beam report has a higher priority than the CSI.

Rule #2 is applied only to the periodic CSI report and the semi-persistent reports for the PUCCH.

Next, Rule #3 is applied.

According to Rule #3, the priority is determined by cellID, PCell has a higher priority than PSCell, and PSCell has a higher priority than the remaining CellIDs.

In this case, the remaining CellIDs have a higher priority in which the cellID increases.

Rule #3 is applied to all periodic CSI reports and the semi-persistent reports for the PUCCH.

Next, Rule #4 is applied.

According to Rule #4, the priority is determined by csiReportID and csiReportID has a higher priority in which csiReportID increases.

Rule #4 is applied to all periodic CSI reports and the semi-persistent reports for the PUCCH.

In the present disclosure, proposed is a method for more effectively reporting the CSI in a wireless communication environment such as Coordinated Multi Point (CoMP) which a plurality of cells and/or base stations cooperate with each other to support the UE.

The CoMP technique is a scheme in which multiple base stations exchange or utilize channel information (e.g., rank indicator (RI), channel quality information (CQI), precoding matrix indicator (PMI), layer indicator (LI), etc.) fed back from the UE with each other to cooperatively transmit the feedback channel information to the UE and effectively control interference.

In this case, multiple base stations may exchange channel information fed back from the UE with each other by using an X2 interface.

According to a scheme using the channel information fed back from the UE, types of CoMP may be classified into Joint transmission (JT), Coordinated scheduling (CS), Coordinated beamforming (CB), dynamic point selection (DPS), dynamic point blanking (DPB), etc.

The CoMP will be described below.

i) CS/CB

The CS/CB system is a system in which data is received from one TRxP, and the remaining TRxPs perform scheduling or beamforming to minimize the interference.

For example, when beamforming for transmitting data from TRxP1 to a specific UE, other TRxPs that may interfere with the specific UE use a beam pattern of a predetermined shape to reduce the interference according to the beam pattern selected by TRxP1.

ii) JT

The JT system is a system that transmits the same data from two or more TRxPs to the UE.

Since the same data is transmitted from an adjacent cell or adjacent TRxP when applying the JT system, a signal received from the adjacent cell becomes not the interference but a data signal to acquire a diversity effect or a signal reinforcement effect.

iii) DPS/DBP

The DPS system is a system in which multiple cells share and transmit the same data like the JT system and the DBP system means a system that turns off a signal transmitted in a resource configured by TRxPs.

However, unlike JT, actual data transmission is performed only through one cell having a minimum path loss according to the channel state of the UE in each subframe, and the remaining cells that are not selected are muted.

As a result, since data is received from a cell having a better channel state, reception performance of the UE is increased, thereby enhancing throughput at a cell boundary.

In the present disclosure, a method for feeding back the CSI when the JT technique is used in which the plurality of base stations cooperate with each other to transmit data to the UE will be mainly described.

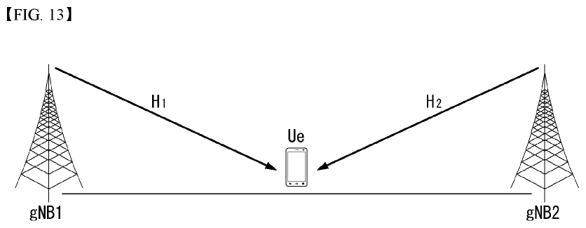

FIG. 13 is a diagram illustrating a CoMP configuration using a JT technique in which a method proposed in the present disclosure is performed.

That is, FIG. 13 is a diagram for an operation in which two base stations (gNB or transmission reception point (TRxP)) perform joint transmission.

As illustrated in FIG. 13, the UE may measure and/or calculate each channel Hi (which is a channel between i-th TRxP and the UE, i=1, 2) between each base station and the UE by using CSI-RSs transmitted from each base station and the UE may feed back the measured and/or calculated channel information to each base station by using the measured and/or calculated channel.

Each base station may receive a feedback for the channel information from the UE and perform joint transmission using the channel information.

Hereinafter, a specific method in which the UE transmits the feedback for the channel information to each base station will be described.

Furthermore, hereinafter, the TRxP may be used interchangeably as the base station.

(Method 1)

Method 1 is a method in which in the case of JT of 2 TRxP CoMP in which 2 TRxPs are joined, the UE measures and/or calculates the channel between the UE and each TRxP, reports RI and PMI (e.g., RI1, RI2, PMI1, PMI2) for each TRxP to each TRxP, and calculates one composite CQI and reports the calculated composite CQI to each TRxP.

That is, the UE measures/calculates parameters related to the channel state with each TRxP, and specifically, the UE may measure and/or calculate parameters RI1 and PMI1 related to the channel state between first TRxP (TRxP1) and the UE and report the measured and/or calculated RI1 and PMI1 to the first TRxP and the UE may measure and/or calculate parameters RI2 and PMI2 related to the channel state between second TRxP (TRxP2) and the UE and report the measured and/or calculated RI2 and PMI2 to the second TRxP.

In a current NR system, the number of codewords (CWs) is determined according to the number of transmitted layers.

When the number of layers, N is larger than 4 (when (# of layers (N) >4), two codewords are used and when N is equal to or smaller than 4 (when N is equal to or smaller than 4), one codeword is used.

Therefore, in the 2 TRxP CoMP proposed in the present disclosure, when considering a mapping rule between the codeword and the layer applied in the current NR system, CQI calculation may vary according to a total RI (RI_T) value which the UE reports to the TRxP.

In this case, the total RI (RI_T) value is determined as the sum of RI1 and RI2.

In this case, RI1 and RI2 and PMI1 and PMI2 may correspond to TRxP1 and TRxP2, respectively or correspond to DMRS group 1 and DMRS group 2, respectively and here, it may be assumed that the DMRS groups are Quasi Co-Location) with each other.

In this case, in the PMI measured and/or calculated by the UE, Type I codebook, Type II codebook, or LTE codebook defined in the existing NR system may be used, or a codebook newly defined for CoMP may be used.

In addition, a co-phase of jointing a wide band and/or a combination of a wide band and a subband (WB and/or WB+SB) to compensate for the phase and/or amplitude between two TRxPs (co-phase) may be applied additionally.

Meanwhile, since a difference between the subbands may be smaller than a phase difference, the compensation for the amplitude may be continuously configured as wide band co-phase.

Therefore, in the case of reporting added PMI, PMI is added to PMI (e.g., PMI1) corresponding to specific TRxP (e.g., TRxP1) and reported or the base station may additionally notify, to the UE, for which TRxP the PMI is to reported while being included in the PMI or CSI report.

A report for a TRxP index may be replaced with the CRI, RI, CQI, and PMI for each CRI may be reported, and furthermore, one CRI may correspond to one CW.

1) When RI_T is equal to or smaller than 4 (when RI_T<=4), one composite CQI may be reported to the base station and when RI_T is larger than 4 (when RI_T>4), two CQIs (CQI1 and CQI2) may be reported to the base station.

When the UE reports one composite CQI to the base station, indication information for MCS corresponding to the reported composite CQI is transmitted to the UE only in the specific TRxP and not transmitted in TRxP which participates in the CoMP.

For example, the specific TRxP in this case, may be TRxP1 or TRxP corresponding to lowest or highest cell id.

In order to eliminate ambiguity of a UE operation for a CoMP situation, the TRxP may make an indicator indicating that a CoMP operation or the MCS is not transmitted be included in the DCI.

Alternatively, when the total number of DMRS ports of two TRxPs is equal to or smaller than 4, the UE may ignore the MCS transmitted in the TRxP other than the specific TRxP.

When RI_T is larger than 4 (when RI_T>4), values of CQI1 and CQI2 may correspond to CW1 and CW2, respectively.

Furthermore, the UE may unconditionally report CQI1 and CQI2 regardless of a reported total rank.

It may be appreciated that a CSI feedback corresponding to each TRxP, which the UE transmits to each TRxP may be independently configured for each CSI report setting.

In this case, CQI1 and CQI2 may correspond to TRxP1 and TRxP2, respectively or correspond to transmitted DMRS group 1 and DMRS group 2, respectively and CQI1 and CQI2 may be mapped to CW1 and CW2, respectively.

In this case, when Method 1 described above is applied, cases of two exceptions may occur, and a first exception is a case where RIi reported to the specific TRxP is 0 (e.g., i=1, 2 and indicates the TRxP index) and a second exception is a case where reported RIi is more than 4.

In the remaining cases other than two exceptions, for example, even when RI_T is 4 (when RI_T=4 and RI1, RI2=(2,2)), the UE regards that two CWs other than one CW are applied, and calculates and reports each of CQI1 and CQI2.

Meanwhile, the PMI and the CQI values corresponding to in the case where RI is 0 (in case of RI=0) may not be reported or may be reported as being padded with zero in order to reduce the payload. In this case, additional 1 bit is further required for an RI field which the UE transmits to the base station in order to indicate the case where the RI is 0.

Accordingly, the UE configured and/or applied with the CoMP mode may recognize the size of the field additionally including 1 bit in addition to the value calculated by the RI restriction.

Furthermore, in order to reduce the payload, when the UE does not report the PMI, the CQI, and/or the RI, the UE may additionally report, to the base station, a separate indicator and/or a target TRxP indicator indicating whether to report the CSI. This is to eliminate determination ambiguity of the base station.

On the other hand, when the UE does not report the RI, since information on the RI itself is not required, reporting the separate indicator may be omitted.

In this case, the target TRxP indicator means an indicator indicating which TRxP the CSI is a CSI corresponding to.

The indicator(s) may be encoded with a priority over CSI encoding, determine the payload of the CSI, and may be joint encoded with HARQ ACK/NACK information.

In the case of the 2 TRxP CoMP, the case where the RI is 0 may mean that the CoMP is operated for the purpose of Dynamic Point Selection (DPS). That is, the UE may implicitly or explicitly notify an operation technique of the CoMP by using RI information.

Meanwhile, the indicator is not newly created or the purpose of the LI is changed to be used for the purpose of indicating optimal TRxP or a resource of the optimal TRxP.

2) In the case where RI_T is larger than 4 (in case of RI_4>4), the UE reports two CQIs to the TRxP according to the mapping rule between the CW and the layer.

For example, in case of RI_T=8, RI1=6, RI2=2.

In the case where RI is equal to or larger than 4, two CWs are used. Therefore, since RI1=6, the UE should report two CQI values corresponding to two CWs for RI1, and as a result, the number of CWs finally transmitted by the UE may be scheduled to up to three (two in TRxP1 and one in TRxP2).

In order to prevent the UE from being scheduled with up to three CWs, the UE reports two CQIs (CQI in TRxP1) in the CQI report, but the UE expects to schedule the MCS b using CQI corresponding to specific CQI (e.g., highest CQI) of two CQIs reported to the base station (TRxP), and as a result, the UE does not expect that a layer exceeding rank 4 is transmitted in one TRxP or DMRS port group.

Alternatively, when an RI value corresponding to predetermined TRxP not 0 from when the UE configured as CoMP JT reports the CQI to the base station, the maximum value of the RI that may be reported may be restricted to 4.

Restriction for the reported RI may be determined rank restriction information indicated by the RRC, and when the UE is configured as a CoMP UE, the reported RI is given as min{min(RI1,4)+min(RI2,4), R_rest} and here, R_rest is information on rank restriction.

During the CoMP operation, the rank restriction information may be configured for each TRxP for the degree of freedom of the configuration.

Meanwhile, in the case of LI for mapping a phase-tracking reference signal (PTRS), as many layers as the number of DMRS port groups or the number of TRxPs may be reported, the RI corresponding to the corresponding DMRS port group is 0 or 1 (RIi=0 or RIi=1), reporting on the layer may be omitted.

(Method 2)

Method is a method in which in the case of independent layer JT of the 2 TRxP CoMP, the UE measures and/or calculates the channel between the UE and each TRxP to calculate and report single CSI (e.g., RI, PMI, CQI, and/or LI).

In other words, Method 2 relates to a method in which in a situation of the 2 TRxP CoMP, the UE calculates the RI, PMI, CQI, and/or LI by using one common codebook and reports the calculated RI, PMI, CQI, and/or LI to the base station.

When such Method 2 is used, a CSI-RS port configuring and common codebook applying scheme for measuring the CSI may include two following specific methods.

i) Different CSI-RSs transmitted in each TRxP are aggregated to apply the common codebook.

ii) One CSI-RS resource for the CoMP is separately configured and then, the common codebook is applied to the CSI-RS resource.

First, in the case of i), a codebook configuration scheme may be applied without a port numbering scheme to be described below.

In the case of using ii), for a CSI-RS configuration degree of freedom for the CoMP, CSI-RS resources for all multiples of 2 may be specifically defined (e.g., defined in a standard document).

As an example, 1, 2, 4, 6, 8, 10, 12, 14, 16, . . . 32 port CSI-RSs may be included. However, in the port CSI-RS resource design, since some CSI-RS ports are used only for the CoMP operation, one new resource may be defined by combining a plurality of CSI-RS resources.

For example, if the UE has CSI-RS resource 1 and CSI-RS resource 2 to be transmitted in each TRxP, the UE may perform CSI-RS port numbering to combine CSI-RS resources 1 and 2 into one CSI-RS resource and apply a common codebook to the combined CSI-RS resources.

Since the port numbering is closely related to the codebook structure, a new port numbering rule is required when using the existing codebook structure.

For example, co-phase for each antenna polarization represented by Type I single panel codebook and/or Type II codebook may be applied.

In addition, in the codebook to which the CSI-RS port numbering is applied in the order of polarization, first X/2 port CSI-RSs among all X-port CSI-RSs may correspond to antenna ports corresponding to one same one slant (e.g., H-slant) and the remaining X/2 ports CSI-RSs may correspond to antenna ports corresponding to the opposite slant (e.g., V-slant).

Accordingly, as described above, when two CSI-RS resources are combined, the CSI-RS port numbering follows the following scheme.

Specifically, it is assumed that an X1-port CSI-RS resource is transmitted in the TRxP1, and an X2-port CSI-RS resource is transmitted in the TRxP2 and the port numbering follows Equation 2 below.

$$p = \frac{{Σ}_{i = 1}^{M} {X}_{i}}{2} ( i - 1 ) + {{p}_{i}}^{′} \qquad [ Equation 2 ]$$

In Equation 2, i has values of 1 and 2, M means the number of TRxPs for the CoMP, and Xᵢ means an antenna port in which the CSI-RS resource is transmitted in i-th TRxP.

In the Type I and/or Type II codebook applied in the NR system, the number of CSI-RS ports is 2, 4, 8, 12, 16, 24, and 32. For example, when X1=2 and X2=4, a codebook for 6(X1+X2) ports may be required.

In this case, for a codebook for 6 ports, a codebook corresponding to the number of CSI-RS ports satisfying all combinations may be newly defined or the existing defined codebooks may be overlapped and used.

For example, there may be rank 1 codebook in which RI1=RI2=1 and

$$[ \begin{matrix}{v}_{1} \\ {φ}_{1} {v}_{1}\end{matrix} ] , [ \begin{matrix}{v}_{2} \\ {φ}_{2} {v}_{2}\end{matrix} ]$$

correspond to X1-port and X2-port, respectively.

In this case, vᵢ as

$${v}_{i} ∈ {C}^{\frac{{X}_{i}}{2} \times 1}$$

represents a codeword (in particular, configured by a 2D DFT beam in the case of an LTE/NR codebook) selected in a codebook corresponding to the existing or new defined Xi-port and ϕᵢ represents an intra co-phase of each i-th TRxP (or corresponding to Xi-port CSI-RS) and is configured in units of the subband.

If another codebook other than a codebook considering an X-polarization (X-pol) antenna shape is used, each codebook may be replaced with vᵢ∈C^{x}^{ₛ}^{×1} without ϕᵢ and another codebook other than the DFT codebook may be used.

In the present disclosure, the description will be focused on a case where

$$[ \begin{matrix}{v}_{1} \\ {φ}_{1} {v}_{1}\end{matrix} ] , [ \begin{matrix}{v}_{2} \\ {φ}_{2} {v}_{2}\end{matrix} ]$$

considering the X-polarization antenna shape is used for the X1-port and the X2-port.

In this case, the form of the final codebook may be configured as

$$[ \begin{matrix}{v}_{1} & 0 \\ 0 & {ρ v}_{2} \\ {φ}_{1} {v}_{1} & 0 \\ {0}_{2} & {ρφ}_{2} {v}_{2}\end{matrix} ]$$

or when there is no separated port numbering as in the method of i), the codebook may be configured by combining in the order of the CSI-RS resources as in

$$[ \begin{matrix}{v}_{1} & 0 \\ {φ}_{1} {v}_{1} & 0 \\ 0 & {ρ v}_{2} \\ {0}_{2} & {ρφ}_{2} {v}_{2}\end{matrix} ] .$$

Here, ρ represents intra co-phase/amplitude to compensate for the phase and/or the amplitude for each TRxP and ρ may be configured and/or applied, and reported in units of the wideband or in units of a combination of the wideband and the subband.

Meanwhile, the amplitude may be continuously configured and/or applied, and reported in units of the wideband. The reason is that a change in different of an optimal value of the amplitude for each subband may be smaller than that of the phase.

When the amplitude is reported in units of the combination of the wideband and the subband, a payload of wideband ρ has a larger than the payload of subband ρ and the subband ρ has a relatively smaller value than the wideband ρ.

For example, the wideband ρ may be reported as 2 bits and the subband ρ may be reported as 1 bit, and when amplitude and phase are reported at the same time, the properties of amplitude and phase for each ρ may be independently applied and/or configured, and reported.

The base station may indicate phase or amplitude information (e.g., size, constituent values, etc.) for each TRxP to the UE by using a higher layer (e.g., RRC or MAC CE) or dynamic signaling (e.g., DCI).

In this case, the phase or amplitude information may be independently configured and/or indicated according to a wideband or subband property.

When the aforementioned wideband ρ is 2 bits and the subband ρ is 1 bit, the wideband ρ may become {1, j, −1, −j}*exp(θ_{WB}) when QPSK {1, j, −1, −j} or QPSK rotates at a specific angle and the subband ρ may be constituted by {1, j} or {exp(−θ_{SB}), exp(θ_{SB})} for the purpose of fine tuning for a wideband phase.

In this case, information related to θ_{WB} orθ_{SB} may be signaled from the base station to the UE or the UE may recommend or feed back a value related to the θ_{WB} or θ_{SB} to the base station by considering a channel situation.

The codebook configuration principle has been described as an example of the CSI feedback in the CoMP situation, but the codebook configuration principle may be applied even to a plurality of panels.

For example, the base station which has the plurality of panels may configure a single CSI-RS resource in the UE and may use the configured CSI-RS resource for intern-panel phase compensation of a multi-panel codebook applied in a situation in which the base station receives a report for the CSI feedback from the UE.

In the CSI report of the codebook configuration, the RI is configured with a separate field for each TRxP.

For example, when RI=6 bits, 3 bits may be allocated for each TRxP.

In addition, the bit field may be variable due to a characteristic restriction or including a new state such as RI=0.

In the case of the PMI, PMIi corresponding to RIi determined in the RI field may be reported according to the TRxP configured above and/or the PMI may be reported while ρ has a separate field. Meanwhile, in the case of independent layer JT, ρ may be omitted.

In addition, in respect to the CQI, according to the sum of RI values, when the RI is equal to or smaller than 4 (RI<=4), one CQI may be reported to the base station and when the RI is larger than 4 (RI>4), two CQIs may be reported to the base station or the CQI may be calculated by Method 1 described above and reported.

If the codebook is configured as described above or Method 1 is followed, overhead may increase depending on the number of TRxPs, so an oversampling value of the codebook configuration for adjusting the increased overhead may be set and/or applied for each TRxP or recommended by the UE.

Alternatively, when the base station is configured to the CoMP, codebook subsampling or codebook subset restriction (CSR) may be applied and/or configured for each Xi port (or each CSI-RS resource).

This is to configure a codebook size and/or mode for more flexible overhead control and performance enhancement.

In the codebook sub-sampling, when a 2D DFT codebook is used, subsampling for each region may be independently performed and/or applied for flexible configuration.

In this case, when CSR or subsampling is applied, it is preferable that the reporting payload is also reduced accordingly.

Whether to apply the CSR or subsampling may be indicated by higher layer signaling (e.g., RRC, MAC CE, DCI, etc.).

It may be most ideal that the CSR is applied independently for each codebook for the CSI-RS of each TRxP.

However, when CSI-RS resources and/or reporting settings are configured around a specific TRxP (e.g., serving TRxP), and each TRxP is controlled by an independent bitmap, large RRC overhead may be required.

Therefore, in this case, it is necessary to design the CSR to control all CoMP/non-CoMP situations with one bitmap configured as RRC, and accordingly, when one CSR bitmap may be differently configured and/or applied depending on CoMP/non-CoMP.

For example, the UE may appreciate that CSR in the non-CoMP mode adopts DFT beam based CSR (a specific DFT beam is reported-restricted by the bitmap) of the existing NR and appreciated that CSR in the CoMP mode adopts beam-group based CSR and/or subsampled beam group based CSR and/or CSR including reporting restriction a phase and/or amplitude corrector.

Further, the RI may be constituted by one common field, may restrict all TRxPs to use vᵢ suitable for the RI, and may be reported by differently setting only a value of ρ.

A method may be considered, which restricts all TRxPs to have the same Xi value and/or restricts all TRxPs to use only Type I codebook in order to reduce the overhead of the PMI.

The base station promises in advance that CSI for a specific TRxP (e.g., serving TRxP) is reported as a high resolution codebook such as Type II CSI, and the rest are reported as a low resolution codebook such as Type I, or the codebook type and/or mode may be independently configured for Teach RxP (or for each CSI-RS).

The independent layer JT is suitable for non-coherent transmission for each TRxP and a method for commonly applying the RI is suitable for coherent transmission.

In addition, the description was made focusing on the case of two TRxPs, but even in the case of a CoMP in which 3 or more TRxPs participate, a specific number of TRxPs may be coherent, and the rest are partially coherent transmissions when non-coherent transmissions are performed.

Therefore, for a codebook configuration and CSI reporting suitable for coherency transmission (one of full, partial, and non) of CoMP base stations, the base station may notify the information (information on CoMP configuration, etc.) to the UE by higher layer signaling (RRC, MAC CE, DCI, etc.).

The configuration by MAC CE or DCI of the base station is to dynamically configure the CoMP and CoMP modes.

Further, since the coherent transmission may be related to capability information related to a receiving beam of the UE, the UE may report, to the base station, from how many TRxPs the UE may receive data as capability information and the base station may indicate the CoMP mode and the CSI reporting method to the UE by using the capability information.

(Method 2-1)

When Method 2 is used, CSI-RS density, CDM setting, Pc value setting, QCL setting, etc., may be independently applied for each specific port group.

In other words, each parameter (CSI-RS density, CDM setting, Pc value setting, QCL setting, etc.) for each antenna port of a plurality of TRxPs transmitting the CSI-RS may be independently set and applied.

In this case, the Pc value may mean a ratio of energy per PDSCH resource element and energy per CSI-RS resource element.

For example, when specific port group X is constituted by X1+X2 ports, X1 has a CSI-RS density of 1, and X2 has a CSI-RS density of ½, so that the flexibility of the CSI-RS resource configuration of the network may increase.

In addition, the CDM length and/or pattern applied to the CSI-RS may be applied for each resource or differently for each specific port group.

In addition, since each port group is transmitted from different TRxPs, power control offset (e.g., Pc) values may be independently set, and the QCL setting may also be applied independently.

In this case, the power control offset may include the following contents as defined in the 3GPP standard document, 3GPP TS 38.214.

“powerControlOffset: which is the assumed ratio of PDSCH EPRE to NZP CSI-RS EPRE when UE derives CSI feedback and takes values in the range of [−8, 15] dB with 1 dB step size.

powerControlOffsetSS: which is the assumed ratio of SS/PBCH block EPRE to NZP CSI-RS EPRE.”

Furthermore, the QCL setting may include QCL types A, B, C, and D as described above.

In particular, when specific port groups are configured to different QCL-TypeD, that is, when the UE receives data through different receiving beams, CSI-RS resources corresponding to each configured port group may not be located in the same OFDM symbol and the UE does not expect not to receive the configuration.

In addition, if the UE is a high-end UE and thus a UE capable of forming the receiving beam for each Rx port(s), the aforementioned restriction (CSI-RS resources may not be located in the same OFDM symbol) may not be applied and the UE may report the capability information to the base station.

(Method 2-2)

As the common codebook suitable for the X-port combined in Method 2 described above, a Y-port codebook suitable for a smallest integer satisfying the codebook port among integers which are equal to or larger than X is used.

In other words, as the codebook used for CSI-RS reporting on the combined port, one of the preconfigured codebooks is used, and the codebook at this time is a codebook corresponding the smallest number of antenna ports among a plurality of preconfigured codebooks corresponding to the number of antenna ports larger than a number acquired by aggregating the antenna ports of a plurality of respective TRxPs.

For example, when X is 6 (X=X1+X2, X1=2, X2=4), since there is no codebook corresponding to 5 ports among the preconfigured codebooks, a codebook corresponding to smallest 8 ports among the codebooks corresponding to the number of antennas larger than 6 may be used.

The UE performs the CSI report by nulling or ignoring a row of a specific Y-X in the Y-port codebook and calculating CSI (e.g., RI, CQI, PMI, LI, etc.).

The common codebook considered in Method 2-2 may include Type I and Type II codebooks used in existing LTE and NR.

As an example of applying Method 2-2, when X=2+4, an existing 8-port codebook is used, and two rows corresponding to 8−6 in the 8-port codebook are regarded as nulling to calculate the CSI by substituting 6-port CSI-RS.

Method 2-2 may have a problem that orthogonality may not be guaranteed when the existing codebook is a multi-layer, but has an advantage that it is not necessary to define the codebook for the number of all combinable ports.

That is, since the codebook for all the coupled ports to which ports may be coupled may not be newly defined, there is an effect that the implementation complexity in the UE or the base station may be greatly reduced.

In the above-described example, information on Y-X rows is promised in advance in a specific row(s) (e.g., last Y-X row(s)), or the base station may separately indicate the information to the UE or the UE may additionally report information on a nulled or ignored row to the base station.

In this case, as in Equation 3 below, a specific bitmap in which Y-X rows are indicated as a group (in Equation 3, a 4-bit bitmap, b0, b1, b2, and b3) or a bitmap for each row (Equation 3, 8-bit bitmap) may be reported to the base station.

Alternatively, in order to reduce the payload, information on Y choose (Y-X) (that is,

$$( \begin{matrix}Y \\ Y - X\end{matrix} ) ) )$$

may be combined and encoded and reported to the base station.

Equation 3 below is a table showing an example of a bitmap configuration for nulling an 8-port codebook.

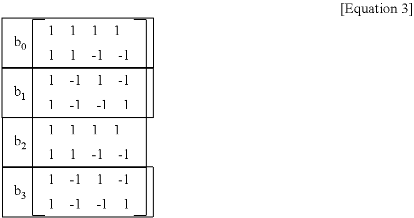

Method 2-2 is applicable even in a non-coherency or partial coherency situation, and in this case, it may be promised in advance that first X1 row indexes are simply mapped to CSI-RS resource 1, and then X2 row indexes are mapped to CSI-RS resource 2.

In addition, the base station may also perform more specific configurations (bit-map, etc.) in the UE.

In this case, the UE may additionally report information how many layers a specific CSI-RS resources (in this case, each resource may correspond to the specific TRxP) or port groups occupy to the base station and the information may correspond to

$$( \begin{matrix}{R}_{T} \\ {R}_{i}\end{matrix} )$$

and this may be included in the PMI field or LI field, and reported.

(Method 2-3)

In order to reduce the implementation complexity of Method 2-2 described above, the X-port coupled for the CoMP may be continuously limited to the number of CSI-RS ports defined in the LTE or NR (in the case of the NR, 2, 4, 8, 12, 16, 24, and 32), and the UE may not expect that a coupled port outside this value is configured.

Hereinafter, a case where there are three TRxPs constituting the CoMP will be described.

(Method 3)

In the case of 3 TRxP CoMP JR in which 2 TRxPs are joined, the UE measures and/or calculates the channel between the UE and each TRxP, reports RI and PMI (e.g., RI1, RI2, PMI1, PMI2) for each TRxP, and calculates one composite CQI and reports the calculated composite CQI to each TRxP.

In the case of Method 3, similarly to Method 1 described above, CW mapping may be different according to the value of R_T=RI+R2+R3.

In this case, in the case of one TRxP, it is assumed that CSI reporting for at least one layer transmission is performed.

For example, if the number of TRxPs is 3, but only 2 TRxPs or 1 TRxP participate in actual data transmission, 2 TRxP JT or DPS may be regarded, and Method 1 or Method 2 described above may be applied.

With this assumption, the transmittable layers of each TRxP for each R_T are as follows.

R_T=3, (R1, R2, R3)=(1,1,1)

R_T=4, (R1, R2, R3)=(2,1,1)

R_T=5, (R1, R2, R3)=(3,1,1), (2,2,1)

R_T=6, (R1, R2, R3)=(4,1,1), (3,2,1), (2,2,2)

R_T=7, (R1, R2, R3)=(5,1,1), (4,2,1), (3,3,1), (3,2,2)

R_T=8, (R1, R2, R3)=(6,1,1), (5,2,1), (4,3,1), (4,2,2), (3,3,2)

In this case, the rank combinations for each TRxP may vary. As described above, when (R1, R2, R3)=(4, 1, 1), a combination of (R1, R2, R3)=(1, 4, 1), (R1, R2, R3)=(1, 1, 4) is also possible.

However, in the present disclosure, for convenience of explanation, it is assumed that since the RSRP or RSRQ of the CSI-RS resource transmitted from the TRxP corresponding to the lowest index is better than the RSRP or RSRQ of the CSI-RS resource transmitted from another TRxP, a support with more ranks may be performed.

Therefore, information indicating from which TRxP an RSRP is good may be reported by the UE to the base station in advance or reported as a separate field when reporting the CSI.

Alternatively, the base station may perform implicit determination by separately setting and/or applying a report quantity of CRI-RSRP used in beam management, or by using the previously reported information (RSRP from TRxP).

In addition, the UE may report the number of TRxPs participating in the CoMP, and this may be implemented in a scheme in which the UE additionally reports the number of reported CRIs to the base station.

As described above, when R_T is equal to or smaller than 4 (when R_T<=4), the layer may be mapped to one CW, and the UE may report one composite CQI.

Meanwhile, when R_T is larger than 4 (R_T>4), a rule for CW and layer mapping may follow the following rule.

Rule 1: RI1 is mapped to one or two CWs, and RI2 and RI3 are mapped to one CW, and accordingly, the UE calculates the CSI.

In this case, RI1 is mapped to two CWs only when RI1 is larger than 4 (RI1>4), and in other cases, that is, when RI1 is equal to or smaller than 4, RI1 is mapped to one CW.

Similar to the case of Method 1 described above, the maximum value of RI1 is limited to 4, or the CQI is reported according to the value of RI1, but the base station may configure and/or restrict the MCS to be fixed to one.

As shown in Method 3 described above, an exceptional case in which RI2+RI3 is 5 is a case of (R1, R2, R3)=(3, 3, 2), but when the rule is followed, the UE may be restricted not to report the CQI for (R1, R2, R3)=(3, 3, 2) to the base station.

Even in the case of 3TRxP JT, by extending Method 2 described above, a single CSI (RI, PMI, CQI, LI) may be applied and/or reported.

(Method 4)

When the UE reports the subband CSI for CoMP JT to the base station, in the case where the CSI for each TRxP is independently reported, in order to reduce the reporting payload, each subband CSI report may be performed with a Comb pattern and the CSI corresponding to each TRxP may be reported with the same or different offsets.

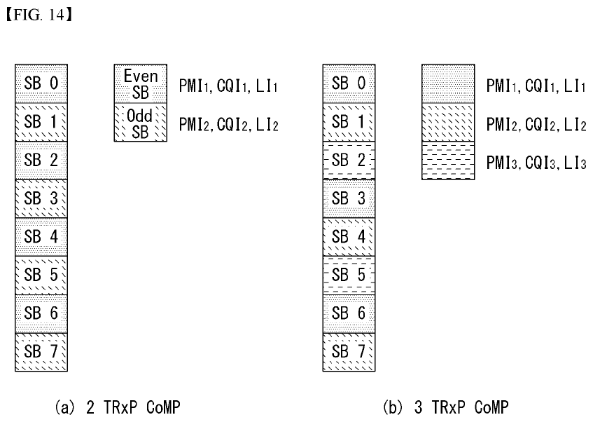

Method 4 will be described again based on FIG. 14.

FIG. 14 is a diagram illustrating an example of CoMP subband reporting, and FIG. 14(a) is a diagram for 2 TRxP CoMP and FIG. 14(b) is a diagram for 3 TRxP CoMP.

According to FIG. 14, a measurement bandwidth for measuring the channel state may be constituted by a plurality of subbands.

For example, when there are 8 reported subbands, 2 TRxPs follow the Comb 2 pattern as illustrated in FIG. 14(a).

That is, CSI (PMI1, CQI1, LI1) of TRxP1 may be reported in the even-numbered subband, and for CSI (PMI2, CQI2, LI2) of TRxP2, CSI corresponding to the odd-numbered subband may be reported.

As illustrated in FIG. 14(b), in the case of 3 TRxP 3, the Comb 3 pattern may be followed, and CSI (PMI1, CQI1, LI1) of TRxP1 may be reported in the 3k (k=0, 1, 2, . . . )-th subband, CSI (PMI2, CQI2, LI2) of TRxP2 may be reported in the 3k+1-th subband, and for CSI (PMI3, CQI3, LI3) of TRxP3, only CSI corresponding to the 3k+2-th subband may be reported.

In other words, this relates to the case in which offsets of different values are set in a comb pattern defined according to a given number of TRxPs or other parameters.

In FIG. 14, all of the PMI, CQI, and LI are shown as the CSI reported by the UE to the base station, but only some of them, for example, only PMI may be transmitted in the Comb pattern, and the remaining CSIs may be reported in units of Comb 1 or wideband.

In the case of the above-described Comb pattern, subbands reported from the standpoint of one TRxP are reported evenly apart, and this has the advantage that frequency selectivity may be reflected in all TRxPs.

As an example of another pattern, for SB0 to SB3, a pattern used as the feedback for the TRxP1 may be considered and for SB4 to SB7, a pattern used as the feedback for the TRxP2 may be considered.

As described above, whether to report a CSI or part of a specific subband pattern corresponding to each TRxP may be promised in advance or the base station may additionally inform the UE of whether to use a pattern including a specific Comb.

Alternatively, when reporting a specific subband, the UE may report the specific subband including an index for a TRxP corresponding to a report CSI for each subband or subband group.

As another example, the UE may report only even-numbered or odd-numbered subband CSI for all TRxPs.

In this case, both the comb pattern and the offset value may be the same, or the length and offset of the comb may be independently applied and/or set.

For example, the CSI for the TRxP1 is Comb 1, that is, CSI for all subbands may be reported, and in respect to the CSI for the TRxP2, only CSI for even-numbered subbands may be reported according to the comb 2 pattern. In this case, it may be appreciated that CSI omission is applied only to the CSI for the TRxP2.

In other words, in the case of the TRxP1, CSI for all subbands is reported, but in the case of the TRxP2, CSI for even (or odd)-numbered subbands is reported, and as a result, CSI for unreported subbands may exist.

As another method, it is possible to increase or decrease the subband size (automatically) in the case of the CoMP, rather than preventing some subband CSI from being reported.

For example, the subband size is set to X PRBs, and if the subband size is increased to X*N PRBs according to the number of TRxPs (or the number of CSI-RS resources) N, the number of subbands for each TRxP is reduced and reported CSI is decreased, and as a result, a similar effect may be obtained.

In order to set the configuration more dynamically, the TRxP may configure a list for a specific subband size or N value at the RRC level, and then dynamically indicate a specific value through MAC CE and/or DCI.

When the report is performed on one PUSCH resource, a dropping/omission rule may be applied to CSI for a specific TRxP (serving cell or lowest cell id) or a specific CSI-RS resource (e.g., a resource having the lowest index or a good CQI), which may be reported preferentially to other CSIs.

(Method 5)

In the environment such as the CoMP, when the codebook based CSI report is configured and/or applied, the TRxP may signal information on the used codebook to the UE or the UE may feed back the information to the TRxP.

When Method 5 above is applied, the UE may report, to the TRxP, the type of codebook for the CSI report as UE capability information in advance.

That is, information on whether the corresponding codebook is a Type I single-panel codebook, a Type II codebook, or whether a new CoMP dedicated codebook is used is included in Part 1 CSI and fed back to the base station (TRxP), or when the capability information of the UE is reported, the capability information including the codebook information may be reported.

For example, in a scheme in which the capability information is included in Part 1 CSI, when only one CSI report is performed for multiple CSI-RSs, Part 1 CSI information including the codebook type may be reported for each resource or the base station and the UE may mutually define that the same codebook type is configured for all resources.

Alternatively, the used codebook may be determined by the configured CoMP mode and other reported CSI (e.g., CRI, RI, CQI, LI).

Hereinafter, in 2 TRxP CoMP, an embodiment in which it is assumed that one CSI-RS resource is transmitted by each TRxP will be described.

Embodiment 1: CRI1=1, CRI2=None

In the case of Embodiment 1, it may be appreciated that the UE performs the DPS and selects TRxP 1 and in this case, the used codebook is the single-panel codebook and both Types I and II are applicable and the information may be included in Part 1 CSI and reported to the TRxP or the UE may receive the configuration for the information or the UE an the TRxP may promise the information therebetween in advance.

Embodiment 2: CRI1=none, CRI2=2

In the case of Embodiment 2, it may be appreciated that the UE performs the DPS and selects TRxP 2 and in this case, the used codebook is the single-panel codebook and both Types I and II are applicable and the information may be included in Part 1 CSI and reported to the TRxP or the UE may receive the configuration for the information or the UE an the TRxP may promise the information therebetween in advance.

Embodiment 3: CRI1=1, CRI2=2 (Common Layer JT)

Embodiment 3 is a case of using common layer JT. [ 6 0 6 ] The UE may appreciate that the new codebook or multi-panel codebook for the common layer JT is applied and the UE may perform CSI reporting for CSI-RS resources indicated by CRI 1 and CRI 2 by single reporting.

Embodiment 4: CRI1=1, CRI2=2 (Independent Layer JT)

Embodiment 4 is a case of using independent layer JT.

The UE may perform independent CSI reporting for each CSI-RS resource and it may be appreciated that the codebook used in this case uses single panel Type I or single panel Type II.

Information indicating whether Type I or Type II is used may be included in Part 1 CSI reported by the UE or reported to the TRxP or the UE may receive the configuration related to the information from the TRxP or the information may be promised in advance between the UE and the TRxP.

As described in Embodiments 1 to 4 described above, information on the used codebook type may be implicitly determined by applied and/or implemented reporting contents.

Further, according to whether the JT is independent layer JT or common layer JT, whether the codebook type is the single-panel codebook or the multi-panel codebook may be implicitly tied and determined.

Alternatively, the TRxP may signal the information such as the type of codebook to be used by the UE to the UE in advance through higher layer (e.g., RRC or MAC CE) signaling or dynamic signal or the type of codebook to be used by the UE may be implicitly determined according to the configured resource.

(Method 6)

When multiple CSI-RS resources configured in the CoMP perform multi-CSI reporting, in the case where the reported CSIs collide and CSI having a lower priority is dropped, reported CSI for the CoMP is fallen back to non-CoMP CSI and the CSI is recalculated and reported.

In the case of CoMP CSI (in particular, in the case of JT) configured to include Methods 1 to 4 described above, time/frequency resources of the channel in which the CSI is carried may be overlapped, an dropped or omitted.

In this case, performance degradation may occur due to a mismatch of CQI and PMI and/or RI, and accurate channel state measurement with the reported CSI.

Accordingly, the UE may fall back to a non-CoMP mode on a channel having a higher priority, or perform the DPS to recalculate the CSI, and report the recalculated CSI to the base station.

The above-described methods have been described mainly in the CoMP JT environment, but are not limited thereto, and may be applied to and/or used in CoMP DPS/DPB/CS/CB.

In addition, although the description has been made based on a plurality of TRxP transmissions in the present disclosure, the present disclosure is not limited thereto, and may be applied to a plurality of panels or a plurality of beams within a single base station.

Signals transmitted from different base stations, TPs, panels, and beams may be distinguished from a signal transmitted from in the same base station, TRxP, panel, and beam in that long-term fading such as pathloss, average delay, and average Doppler shift may be different and a beam (QCL w.r.t. spatial Rx parameter, QCL type D) which the UE is to apply to reception may be different.

That is, antenna ports transmitted and/or received in the same TRxP are QCLed antenna ports (e.g., CSI-RS antenna ports within the same resource) and antenna ports transmitted and/or received in different TRxPs may be classified into non-QCLed antenna ports (e.g., CSI-RS antenna ports in different CSI-RS resources).

Each embodiment or each method described above may be performed separately, and is performed by a combination of one or more embodiments or methods to implement the method proposed in the present disclosure.

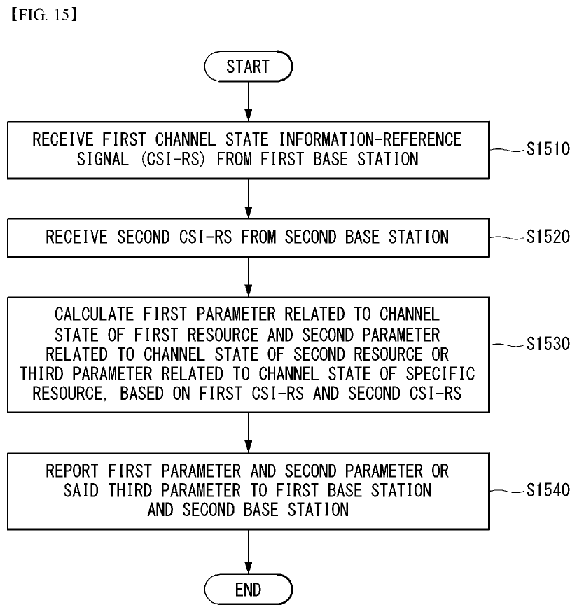

FIG. 15 is a flowchart illustrating one example of an operation method of a UE that performs a method proposed in the present disclosure.

That is, FIG. 15 illustrates an operation method of a UE that performs a method for reporting channel state information in a wireless communication system.

First, the UE receiving a first Channel State Information-Reference Signal (CSI-RS) from a first base station and a second CSI-RS from a second base station (S1510 and S1520).

The UE calculates a first parameter related to a channel state of a first resource and a second parameter related to a channel state of a second resource or a third parameter related to a channel state of a specific resource based on the first CSI-RS and the second CSI-RS (S1530).

The UE reports the first parameter and the second parameter or the third parameter to the first base station and the second station (S1540).

In this case, the first resource may be a resource fora channel through which the first CSI-RS is transmitted and the second resource may be a resource for a channel through which the second CSI-RS is transmitted.

In this case, the codebook may be determined based on a first value acquired by adding the number of antenna ports for transmitting the first CSI-RS and the number of antenna ports for transmitting the second CSI-RS, and the codebook may be a codebook corresponding to the smallest number of antenna ports among a plurality of codebooks corresponding to the number of antenna ports larger than the first value.

In this case, in the codebook, a specific number of rows may be excluded according to the first value, and the specific number may be a number acquired by subtracting the first value from the number of antenna ports corresponding to the codebook.

In this case, the specific resource may be a resource generated through aggregation of the first resource and the second resource.

In this case, numbers of the first antenna ports and the second antenna ports may be reset based on the codebook.

In this case, the specific resource may be a resource for transmitting a third CSI-RS acquired by combining the first CSI-RS and the second CSI-RS.

In this case, step S1540 may include reporting the first parameter to the first base station, and reporting the second parameter to the second base station.

In this case, the first parameter and the second parameter may be calculated in a partial subband of a bandwidth constituted by a plurality of subbands according to a specific pattern.

In this case, the specific pattern may be a pattern in which the first parameter is calculated in an even-numbered subband among the plurality of subbands, and the second parameter is calculated in an odd-numbered subband among the plurality of subbands.

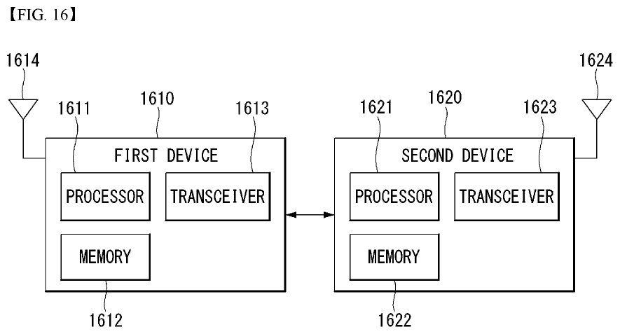

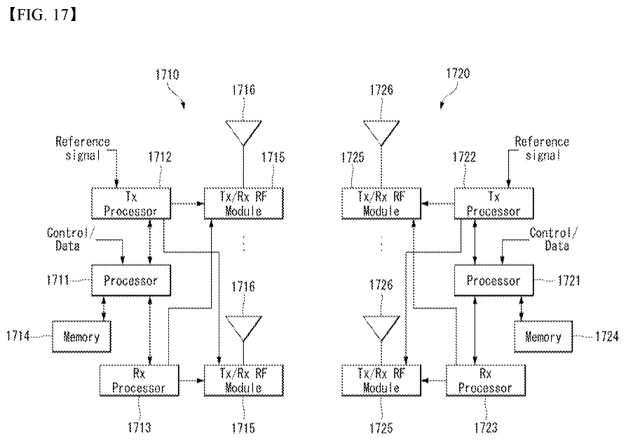

Referring to FIGS. 16 and 17, contents that the method for reporting the channel state information proposed in the present disclosure is implemented in the terminal device will be described.

A reporting Channel State Information (CSI) in a wireless communication system may include a radio frequency (RF) module transmitting and receiving a radio signal; and a processor functionally connected to the RF module.

First, the processor of the UE controls the RF module to receive a first Channel State Information-Reference Signal (CSI-RS) from a first base station and a second CSI-RS from a second base station.

In addition, the processor controls the RF module to calculate a first parameter related to a channel state of a first resource and a second parameter related to a channel state of a second resource or a third parameter related to a channel state of a specific resource based on the first CSI-RS and the second CSI-RS.

In addition, the processor the RF module to report the first parameter and the second parameter or the third parameter to the first base station and the second station.

In this case, when the third parameter is calculated, the third parameter may be calculated by using a codebook related to the specific resource, and CSI-RS density, a CDM setting value, a power control offset value, and a Quasi Co-Location (QCL) may be independently configured for each of a first antenna port for transmitting the first CSI-RS and a second antenna port for transmitting the second CSI-RS.

In this case, the first resource may be a resource fora channel through which the first CSI-RS is transmitted and the second resource may be a resource for a channel through which the second CSI-RS is transmitted.

In this case, the codebook may be determined based on a first value acquired by adding the number of antenna ports for transmitting the first CSI-RS and the number of antenna ports for transmitting the second CSI-RS, and the codebook may be a codebook corresponding to the smallest number of antenna ports among a plurality of codebooks corresponding to the number of antenna ports larger than the first value.

In this case, in the codebook, a specific number of rows may be excluded according to the first value, and the specific number may be a number acquired by subtracting the first value from the number of antenna ports corresponding to the codebook.

In this case, the specific resource may be a resource generated through aggregation of the first resource and the second resource.

In this case, numbers of the first antenna ports and the second antenna ports may be reset based on the codebook.

In this case, the specific resource may be a resource for transmitting a third CSI-RS acquired by combining the first CSI-RS and the second CSI-RS.

In this case, when calculating the first parameter and the second parameter, the processor may control the RF module to report the first parameter and the second parameter to the second station.

In this case, the first parameter and the second parameter may be calculated in a partial subband of a bandwidth constituted by a plurality of subbands according to a specific pattern.

In this case, the specific pattern may be a pattern in which the first parameter is calculated in an even-numbered subband among the plurality of subbands, and the second parameter is calculated in an odd-numbered subband among the plurality of subbands.

Overview of Device to which the Present Disclosure is Applicable

A device to which the present disclosure is applicable is described below.

FIG. 16 illustrates a wireless communication device according to an embodiment of the present disclosure.

Referring to FIG. 16, a wireless communication system may include a first device 1610 and a second device 1620.

The first device 1610 may be a base station, a network node, a transmitter UE, a receiver UE, a wireless device, a wireless communication device, a vehicle, a vehicle with an autonomous driving function, a connected car, a drone (unmanned aerial vehicle (UAV)), an artificial intelligence (AI) module, a robot, an augmented reality (AR) device, a virtual reality (VR) device, a mixed reality (MR) device, a hologram device, a public safety device, an MTC device, an IoT device, a medical device, a FinTech device (or financial device), a security device, a climate/environment device, a device related to 5G services, or a device related to the fourth industrial revolution field, or the like.

The second device 1620 may be a base station, a network node, a transmitter UE, a receiver UE, a wireless device, a wireless communication device, a vehicle, a vehicle with an autonomous driving function, a connected car, a drone (unmanned aerial vehicle (UAV)), an artificial intelligence (AI) module, a robot, an augmented reality (AR) device, a virtual reality (VR) device, a mixed reality (MR) device, a hologram device, a public safety device, an MTC device, an IoT device, a medical device, a FinTech device (or financial device), a security device, a climate/environment device, a device related to 5G services, or a device related to the fourth industrial revolution field, or the like.

For example, the UE may include a cellular phone, a smart phone, a laptop computer, a digital broadcast terminal, a personal digital assistant (PDA), a portable multimedia player (PMP), a navigator, a slate PC, a tablet PC, an ultrabook, a wearable device (e.g., a smart watch, a smart glass, a head mounted display (HMD)), or the like. For example, the HMD may be a display device worn on the head. For example, the HMD may be used to implement the VR, AR, or MR device.

For example, the drone may be a flight vehicle that flies by a radio control signal without a person being on the flight vehicle. For example, the VR device may include a device that implements an object or a background, etc. of a virtual world. For example, the AR device may include a device implemented by connecting an object or a background of a virtual world to an object or a background, etc. of a real world. For example, the MR device may include a device implemented by merging an object or a background of a virtual world with an object or a background, etc. of a real world. For example, the hologram device may include a device that records and reproduces stereoscopic information to implement a 360-degree stereoscopic image by utilizing a phenomenon of interference of light generated when two laser beams called holography meet. For example, the public safety device may include a video relay device or a video device that can be worn on the user's body. For example, the MTC device and the IoT device may be a device that does not require a person's direct intervention or manipulation. For example, the MTC device and the IoT device may include a smart meter, a vending machine, a thermometer, a smart bulb, a door lock, a variety of sensors, or the like. For example, the medical device may be a device used for the purpose of diagnosing, treating, alleviating, handling or preventing a disease. For example, the medical device may be a device used for the purpose of diagnosing, treating, alleviating or correcting an injury or a disorder. For example, the medical device may be a device used for the purpose of testing, substituting or modifying a structure or a function. For example, the medical device may be a device used for the purpose of controlling pregnancy. For example, the medical device may include a medical device, a surgical device, a (in vitro) diagnostic device, a hearing aid or a device for a surgical procedure, and the like. For example, the security device may be a device installed to prevent a possible danger and to maintain safety. For example, the security device may include a camera, CCTV, a recorder, or a black box, and the like. For example, the FinTech device may be a device capable of providing financial services, such as mobile payment. For example, the FinTech device may include a payment device, point of sales (POS), or the like. For example, the climate/environment device may include a device for monitoring and predicting the climate/environment.

The first device 1610 may include at least one processor such as a processor 1611, at least one memory such as a memory 1612, and at least one transceiver such as a transceiver 1613. The processor 1611 may perform functions, procedures, and/or methods described above. The processor 1611 may perform one or more protocols. For example, the processor 1611 may perform one or more layers of a radio interface protocol. The memory 1612 is connected to the processor 1611 and may store various types of information and/or instructions. The transceiver 1613 is connected to the processor 1611 and may be configured to transmit and receive radio signals.

The second device 1620 may include at least one processor such as a processor 1621, at least one memory such as a memory 1622, and at least one transceiver such as a transceiver 1623. The processor 1621 may perform functions, procedures, and/or methods described above. The processor 1621 may perform one or more protocols. For example, the processor 1621 may perform one or more layers of a radio interface protocol. The memory 1622 is connected to the processor 1621 and may store various types of information and/or instructions. The transceiver 1623 is connected to the processor 1621 and may be configured to transmit and receive radio signals.

The memory 1612 and/or the memory 1622 may be connected inside or outside the processor 1611 and/or the processor 1621, respectively, and may be connected to another processor through various technologies, such as a wired or wireless connection.

The first device 1610 and/or the second device 1620 may have one or more antennas. For example, an antenna 1614 and/or an antenna 1624 may be configured to transmit and receive radio signals.

FIG. 17 illustrates another example of a block configuration diagram of a wireless communication device to which methods described in the present disclosure are applicable.

Referring to FIG. 17, a wireless communication system includes a base station 1710 and multiple UEs 1720 located in an area of the base station. The base station 1710 may be represented as a transmitter, and the UE 1720 may be represented as a receiver, or vice versa. The base station 1710 and the UE 1720 respectively include processors 1711 and 1721, memories 1714 and 1724, one or more Tx/Rx RF modules 1715 and 1725, Tx processors 1712 and 1722, Rx processors 1713 and 1723, and antennas 1716 and 1726. The processors implement functions, processes, and/or methods described above. More specifically, in DL (communication from the base station to the UE), an upper layer packet from a core network is provided to the processor 1711. The processor implements functionality of the L2 layer. In the DL, the processor provides the UE 1720 with multiplexing between a logical channel and a transport channel and radio resource allocation and is also responsible for signaling to the UE 1720. The transmit (Tx) processor 1712 implements various signal processing functions for the L1 layer (i.e., physical layer). The signal processing functions include coding and interleaving to facilitate forward error correction (FEC) at the UE. The coded and modulated symbols are split into parallel streams, and each stream is mapped to an OFDM subcarrier, multiplexed with a reference signal (RS) in time and/or frequency domain, and combined together using an Inverse Fast Fourier Transform (IFFT) to produce a physical channel carrying a time domain OFDMA symbol stream. The OFDMA stream is spatially precoded to produce multiple spatial streams. Each spatial stream may be provided to the different antenna 1716 via a separate Tx/Rx module (or transceiver 1715). Each Tx/Rx module may modulate an RF carrier with a respective spatial stream for transmission. At the UE, each Tx/Rx module (or transceiver 1725) receives a signal through the respective antenna 1726 of each Tx/Rx module. Each Tx/Rx module recovers information modulated onto an RF carrier and provides the information to the receive (Rx) processor 1723. The Rx processor implements various signal processing functions of the Layer 1. The Rx processor may perform spatial processing on the information to recover any spatial stream destined for the UE. If multiple spatial streams are destined for the UE, they may be combined into a single OFDMA symbol stream by the multiple Rx processors. The Rx processor converts the OFDMA symbol stream from the time domain to the frequency domain using a Fast Fourier Transform (FFT). The frequency domain signal includes a separate OFDMA symbol stream for each subcarrier of the OFDM signal. The symbols on each subcarrier and the reference signal are recovered and demodulated by determining the most likely signal constellation points transmitted by the base station. These soft decisions may be based on channel estimation values. The soft decisions are decoded and de-interleaved to recover data and control signals that are originally transmitted by the base station on the physical channel. The corresponding data and control signals are provided to the processor 1721.

UL (communication from the UE to the base station) is processed at the base station 1710 in a manner similar to the description associated with a receiver function at the UE 1720. Each Tx/Rx module 1725 receives a signal via the respective antenna 1726. Each Tx/Rx module provides an RF carrier and information to the Rx processor 1723. The processor 1721 may be associated with the memory 1724 that stores a program code and data. The memory may be referred to as a computer readable medium.

In the embodiments described above, the components and the features of the present disclosure are combined in a predetermined form. Each component or feature should be considered as an option unless otherwise expressly stated. Each component or feature may be implemented not to be associated with other components or features. Further, the embodiment of the present disclosure may be configured by associating some components and/or features. The order of the operations described in the embodiments of the present disclosure may be changed. Some components or features of any embodiment may be included in another embodiment or replaced with the component and the feature corresponding to another embodiment. It is apparent that the claims that are not expressly cited in the claims are combined to form an embodiment or be included in a new claim by an amendment after the application.

The embodiments of the present disclosure may be implemented by hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

In the case of implementation by firmware or software, the embodiment of the present disclosure may be implemented in the form of a module, a procedure, a function, and the like to perform the functions or operations described above. A software code may be stored in the memory and executed by the processor. The memory may be positioned inside or outside the processor and may transmit and receive data to/from the processor by already various means.

It is apparent to those skilled in the art that the present disclosure may be embodied in other specific forms without departing from essential characteristics of the present disclosure. Accordingly, the aforementioned detailed description should not be construed as restrictive in all terms and should be exemplarily considered. The scope of the present disclosure should be determined by rational construing of the appended claims and all modifications within an equivalent scope of the present disclosure are included in the scope of the present disclosure.

### INDUSTRIAL APPLICABILITY

Although the present disclosure has been described focusing on examples applying to the 3GPP LTE/LTE-A/NR system, the present disclosure can be applied to various wireless communication systems other than the 3GPP LTE/LTE-A/NR system.

1. A method for reporting Channel State Information (CSI) in a wireless communication system, the method performed by a terminal, comprising:
receiving a first Channel State Information-Reference Signal (CSI-RS) from a first base station;
receiving a second CSI-RS from a second base station;
calculating a first parameter related to a channel state of a first resource and a second parameter related to a channel state of a second resource or a third parameter related to a channel state of a specific resource based on the first CSI-RS and the second CSI-RS; and
reporting the first parameter and the second parameter or the third parameter to the first base station and the second station,
wherein when the third parameter is calculated, the third parameter is calculated by using a codebook related to the specific resource, and
wherein CSI-RS density, a CDM setting value, a power control offset value, and a Quasi Co-Location (QCL) are independently configured for each of a first antenna port for transmitting the first CSI-RS and a second antenna port for transmitting the second CSI-RS.

2. The method of claim 1, wherein the first resource is a resource for a channel through which the first CSI-RS is transmitted and the second resource is a resource for a channel through which the second CSI-RS is transmitted.

3. The method of claim 1, wherein the codebook is determined based on a first value acquired by adding the number of antenna ports for transmitting the first CSI-RS and the number of antenna ports for transmitting the second CSI-RS, and
wherein the codebook is a codebook corresponding to the smallest number of antenna ports among a plurality of codebooks corresponding to the number of antenna ports larger than the first value.

4. The method of claim 3, wherein in the codebook, a specific number of rows are excluded according to the first value, and
the specific number is a number acquired by subtracting the first value from the number of antenna ports corresponding to the codebook.

5. The method of claim 2, wherein the specific resource is a resource generated through aggregation of the first resource and the second resource.

6. The method of claim 5, wherein numbers of the first antenna ports and the second antenna ports are reset based on the codebook.

7. The method of claim 1, wherein the specific resource is a resource for transmitting a third CSI-RS acquired by combining the first CSI-RS and the second CSI-RS.

8. The method of claim 1, wherein when the first parameter and the second parameter are calculated, the reporting of the first parameter and the second parameter to the first base station and the second station includes
reporting the first parameter to the first base station, and
reporting the second parameter to the second base station.

9. The method of claim 8, wherein the first parameter and the second parameter are calculated in a partial subband of a bandwidth constituted by a plurality of subbands according to a specific pattern.

10. The method of claim 8, wherein the specific pattern is a pattern in which the first parameter is calculated in an even-numbered subband among the plurality of subbands, and the second parameter is calculated in an odd-numbered subband among the plurality of subbands.

11. A terminal reporting Channel State Information (CSI) in a wireless communication system, the terminal comprising:
a radio frequency (RF) module transmitting and receiving a radio signal; and
a processor functionally connected to the RF module,
wherein the processor is configured to
receive a first Channel State Information-Reference Signal (CSI-RS) from a first base station,
receive a second CSI-RS from a second base station,
calculate a first parameter related to a channel state of a first resource and a second parameter related to a channel state of a second resource or a third parameter related to a channel state of a specific resource based on the first CSI-RS and the second CSI-RS, and
report the first parameter and the second parameter or the third parameter to the first base station and the second station, and
wherein when the third parameter is calculated, the third parameter is calculated by using a codebook related to the specific resource, and
wherein CSI-RS density, a CDM setting value, a power control offset value, and a Quasi Co-Location (QCL) are independently configured for each of a first antenna port for transmitting the first CSI-RS and a second antenna port for transmitting the second CSI-RS.

12. The terminal of claim 11, wherein the first resource is a resource for a channel through which the first CSI-RS is transmitted and the second resource is a resource for a channel through which the second CSI-RS is transmitted.

13. The terminal of claim 11, wherein the codebook is determined based on a first value acquired by adding the number of antenna ports for transmitting the first CSI-RS and the number of antenna ports for transmitting the second CSI-RS, and
wherein the codebook is a codebook corresponding to the smallest number of antenna ports among a plurality of codebooks corresponding to the number of antenna ports larger than the first value.

14. The terminal of claim 13, wherein in the codebook, a specific number of rows are excluded according to the first value, and
the specific number is a number acquired by subtracting the first value from the number of antenna ports corresponding to the codebook.

15. The terminal of claim 12, wherein the specific resource is a resource generated through aggregation of the first resource and the second resource.

16. The terminal of claim 15, wherein numbers of the first antenna ports and the second antenna ports are reset based on the codebook.

17. The terminal of claim 11, wherein the specific resource is a resource for transmitting a third CSI-RS acquired by combining the first CSI-RS and the second CSI-RS.

18. The terminal of claim 11, wherein when calculating the first parameter and the second parameter, the processor reports the first parameter to the first base station, and reports the second parameter to the second base station.

19. The terminal of claim 18, wherein the first parameter and the second parameter are calculated in a partial subband of a bandwidth constituted by a plurality of subbands according to a specific pattern.

20. The terminal of claim 18, wherein the specific pattern is a pattern in which the first parameter is calculated in an even-numbered subband among the plurality of subbands, and the second parameter is calculated in an odd-numbered subband among the plurality of subbands.
